(19) United States
(12) Patent Application Publication
(10) Pub. No.: US 2023/0156245 A1
(43) Pub. Date: May 18, 2023

(54) SYSTEMS AND METHODS FOR PROCESSING AND PRESENTING MEDIA DATA TO ALLOW VIRTUAL ENGAGEMENT IN EVENTS

(71) Applicant: 15 SECONDS OF FAME, INC., Santa Monica, CA (US)

(72) Inventors: Adam RESNICK, Boca Raton, FL (US); Gregg DONNENFELD, Roslyn, NY (US)

(21) Appl. No.: 17/919,317

(22) PCT Filed: Apr. 17, 2021
(86) PCT No.: PCT/US2021/027847

§ 371 Date: Oct. 17, 2022

Related U.S. Application Data
(60) Provisional application No. 63/011,538, filed on Apr. 17, 2020.
(60) Provisional application No. 63/015,173, filed on Apr. 24, 2020.
(60) Provisional application No. 63/018,314, filed on Apr. 30, 2020.
(60) Provisional application No. 63/067,713, filed on Aug. 19, 2020.

(51) Int. Cl. H04N 21/2187; H04N 21/258; H04N 21/63; H04N 21/414; H04N 21/234

(52) U.S. Cl. CPC H04N 21/2187; H04N 21/632; H04N 21/23418; H04N 21/25866; H04N 21/41415

(57) ABSTRACT

An illustrative example method of hosting a virtual audience during an event at a venue includes distributing an observable representation of the event to be received by a plurality of user devices located remote from the venue; receiving a media stream from each of a plurality of virtual attendees located remote from the venue, each received media stream including a visual representation of at least one of the plurality of virtual attendees; and displaying, on a display at the venue, the visual representation of at least some of the virtual attendees such that the virtual attendees appear to be attending the event at the venue.

### CROSS REFERENCE TO RELATED APPLICATIONS

This application claims priority to U.S. Provisional Application No. 63/011,538, filed Apr. 17, 2020, U.S. Provisional Application No. 63/015,173, filed Apr. 24, 2020, U.S. Provisional Application No. 63/018,314, filed Apr. 30, 2020, and U.S. Provisional Application No. 63/067,713, filed Aug. 19, 2020.

### BACKGROUND

The embodiments described herein relate generally to providing digital content, and more particularly, to systems and methods for virtually engaging in live events.

Increases in the availability and capability of electronic devices such as cameras, computers, mobile devices, etc. have allowed some people to capture media (e.g., take pictures, capture video, and/or record audio) of their experiences. Moreover, increases in the capability and capacity of network systems and increases in the availability of network bandwidth have allowed some people to share media to one or more electronic devices via a network, including real-time or substantially real-time media sharing (e.g., “live streaming” and/or “streaming media”). In some instances, venues and/or events such as sporting events, concerts, rallies, graduations, and/or the like have cameras or other devices capable of capturing media that can take pictures, record video, and/or record audio of the event occurring at the venue and/or of members of the audience who are in attendance. The pictures, video, and/or audio, in turn, can be broadcast via radio, television, and/or one or more networks (e.g., the Internet) allowing people to enjoy the event remotely (e.g., at his or her home, office, via a mobile device, etc.).

While some people are able to watch or listen to broadcast(s) of the event occurring at the venue, such people generally are not able to engage, interact, and/or otherwise be a member of the audience that is physically attending the live event at the venue. Moreover, certain social and/or environmental concerns may at times make it impractical and/or impossible for people to physically attend a live event. For example, “social distancing measures” and/or “stay-at-home orders” in response to a bacterial or viral outbreak or pandemic can be such that audience members are no longer permitted to attend live events. The lack of an audience for the live event, in turn, can have a negative impact on the participants or performers and/or can result in the live event being canceled.

### SUMMARY

An illustrative example method of hosting a virtual audience during an event at a venue includes distributing an observable representation of the event to be received by a plurality of user devices located remote from the venue; receiving a media stream from each of a plurality of virtual attendees located remote from the venue, each received media stream including a visual representation of at least one of the plurality of virtual attendees; and displaying, on a display at the venue, the visual representation of at least some of the virtual attendees such that the virtual attendees appear to be attending the event at the venue.

In an example embodiment having at least one feature of the method of the previous paragraph, the received media stream includes audio representing sounds made by the virtual attendees, and the method includes reproducing the sounds within the venue so the sounds made by the virtual attendees are audible at the venue.

An example embodiment having at least one feature of the method of any of the preceding paragraphs includes determining contextual information corresponding to each received media stream and selecting the at least some of the virtual attendees for the displaying based on the contextual information.

An example embodiment having at least one feature of the method of any of the preceding paragraphs includes using at least one of facial recognition or voice recognition for recognizing at least one individual in each received media stream, including a result of the facial recognition or voice recognition in the contextual information, and selecting the at least some of the virtual attendees based on the included result of the facial recognition or voice recognition.

An example embodiment having at least one feature of the method of any of the preceding paragraphs includes selecting a position of the visual representation of the recognized individual within the venue based on the result of the facial recognition or voice recognition.

An example embodiment having at least one feature of the method of any of the preceding paragraphs includes grouping the visual representation of some of the plurality of virtual attendees within the venue based on the result of the facial recognition or voice recognition.

An example embodiment having at least one feature of the method of any of the preceding paragraphs includes determining at least one other characteristic of the media stream including a recognized individual, and selecting a position of the visual representation of the recognized individual within the venue based on the at least one other characteristic.

An example embodiment having at least one feature of the method of any of the preceding paragraphs includes grouping the visual representation of some of the plurality of virtual attendees within the venue based on a similarity between the determined at least one other characteristic of the respective media streams of the some of the plurality of virtual attendees.

In an example embodiment having at least one feature of the method of any of the preceding paragraphs, the contextual information comprises user profile data regarding a corresponding one of the received media streams, and the method includes determining, based on the user profile data, whether the visual representation of the corresponding one of the received media streams should be included among the displayed virtual attendees.

An example embodiment having at least one feature of the method of any of the previous paragraphs includes establishing a peer networking session between some of the virtual attendees during the event based on at least one of a choice or selection made by one of the virtual attendees to be in the peer networking session with at least one other of the virtual attendees, or the user profile data of each of some of the plurality of virtual attendees indicating an association between the some of the virtual attendees.

An example embodiment having at least one feature of the method of any of the previous paragraphs includes determining that at least one of the virtual attendees appears in the distributed observable representation of the event or appears on a dedicated display at the venue during the event, and sending a media file to the at least one of the virtual attendees during or after the event, wherein the sent media file includes the appearance of the at least one of the virtual attendees.

In an example embodiment having at least one feature of the method of any of the previous paragraphs, the displaying includes placing the visual representation of each of the virtual attendees in a respective tile and selecting a size of the tiles based on a number of virtual attendees on the display.

An example embodiment having at least one feature of the method of any of the previous paragraphs includes selecting at least one of the virtual attendees and displaying the visual representation of the selected at least one of the virtual attendees differently than others of the visual representations of the virtual attendees for at least a portion of the event.

An example embodiment having at least one feature of the method of any of the previous paragraphs includes facilitating an interaction between an individual at the venue participating in the event and the selected at least one of the virtual attendees while displaying the visual representation of the selected at least one of the virtual attendees differently than others of the visual representations of the virtual attendees.

An example embodiment having at least one feature of the method of any of the previous paragraphs includes removing the visual representation of one of the virtual attendees from the display based on at least one characteristic of the received media stream from the at least one of the virtual attendees, wherein the at least one characteristic is a quality below a minimum quality threshold, a connection rate below a minimum threshold, a loss of data packets, an absence of the visual representation of the one of the virtual attendees, or inappropriate content.

An illustrative example embodiment of a system for hosting a virtual audience during an event at a venue includes a camera arrangement situated at the venue. The camera arrangement is configured to capture an observable representation of the event. A distribution device is configured to distribute the observable representation of the event to be received by a plurality of user devices located remote from the venue. A host device includes a communication interface configured to receive a media stream from each of a plurality of virtual attendee user devices located remote from the venue. Each received media stream includes a visual representation of at least one of the plurality of virtual attendees. The host device includes at least one processor that is configured to analyze the received media streams and to select at least some of the visual representations of corresponding ones of the plurality of virtual attendees. At least one display is situated at the venue. The host device causes the at least one display to include the visual representation of the selected virtual representations such that the virtual attendees corresponding to the selected visual representations appear to be attending the event at the venue.

In an example embodiment having at least one feature of the system of the preceding paragraph, the at least one display comprises a display panel that is configured to include multiple visual representations of virtual attendees, or a plurality of display panels each configured to include a single visual representation of a corresponding virtual attendees.

An example embodiment having at least one feature of the system of any of the preceding paragraphs includes at least one speaker, wherein the received media streams includes audio representing sounds made by the virtual attendees, and wherein the host device causes the at least one speaker to reproduce the sounds within the venue so the sounds made by the virtual attendees are audible at the venue.

In an example embodiment having at least one feature of the system of any of the preceding paragraphs, the at least one processor is configured to analyze each received media stream to determine contextual information corresponding to each received media stream, and select the at least some of the visual representations for the displaying the virtual attendees based on the contextual information.

In an example embodiment having at least one feature of the system of any of the preceding paragraphs, the at least one processor is configured to use at least one of facial recognition or voice recognition for recognizing at least one individual in each received media stream, include a result of the facial recognition or voice recognition in the contextual information, and select the at least some of the virtual attendees based on the included result of the facial recognition or voice recognition.

In an example embodiment having at least one feature of the system of any of the preceding paragraphs, the at least one processor is configured to select a position of the visual representation of the recognized individual on the at least one display based on the result of the facial recognition or voice recognition.

In an example embodiment having at least one feature of the system of any of the preceding paragraphs, the at least one processor is configured to group the visual representation of some of the plurality of virtual attendees on the at least one display based on the result of the facial recognition or voice recognition.

In an example embodiment having at least one feature of the system of any of the preceding paragraphs, the at least one processor is configured to determine at least one other characteristic of the media stream including a recognized individual, and select a position of the visual representation of the recognized individual on the at least one display based on the at least one other characteristic.

In an example embodiment having at least one feature of the system of any of the preceding paragraphs, the at least one processor is configured to group the visual representation of some of the plurality of virtual attendees on the at least one display based on a similarity between the determined at least one other characteristic of the respective media streams of the some of the plurality of virtual attendees.

In an example embodiment having at least one feature of the system of any of the preceding paragraphs, the contextual information comprises user profile data regarding a corresponding one of the received media streams, and the at least one processor is configured to determine, based on the user profile data, whether the visual representation of the corresponding one of the received media streams should be included among the displayed virtual attendees.

### BRIEF DESCRIPTION OF THE DRAWINGS

FIG. 1 is a schematic illustration of a virtual engagement system according to an example embodiment.

FIG. 2 is a schematic illustration of a user device included in the virtual engagement system of FIG. 1.

FIG. 3 is a schematic illustration of a host device included in the virtual engagement system of FIG. 1.

FIG. 4 is a flowchart illustrating a method of virtually engaging in a live event occurring at a venue according to an example embodiment.

FIG. 5 is an illustration of a venue with a virtual audience, according to an example embodiment.

### DETAILED DESCRIPTION

The embodiments described herein relate to systems and methods for transferring, processing, and/or presenting media data to allow one or more users to virtually engaging in live events. In some implementations, for example, a method of virtually engaging in live events occurring at a venue can include streaming media captured by a media capture system at a venue. The media can be associated with an event occurring at the venue. Media streamed from a user device is received. At least a portion of the media streamed from the user device is presented on a display at the venue. In some instances, streaming the media captured by the media capture system can include streaming media of the user associated with the user device presented on the display at the venue.

As used in this specification, the singular forms “a,” “an” and “the” include plural referents unless the context clearly dictates otherwise. Thus, for example, the term “a module” is intended to mean a single module or a combination of modules, “a network” is intended to mean one or more networks, or a combination thereof.

Electronic devices are described herein that can include any suitable combination of components configured to perform any number of tasks. Components, modules, elements, engines, etc., of the electronic devices can refer to any assembly, subassembly, and/or set of operatively-coupled electrical components that can include, for example, a memory, a processor, electrical traces, optical connectors, software (executing in hardware), and/or the like. For example, an electronic device and/or a component of the electronic device can be any combination of hardware-based components, modules, and/or engines (e.g., a field-programmable gate array (FPGA), an application specific integrated circuit (ASIC), a digital signal processor (DSP)), and/or software-based components and/or modules (e.g., a module of computer code stored in memory and/or executed at the processor) capable of performing one or more specific functions associated with that component and/or otherwise tasked to that electronic device.

The embodiments described herein relate generally to sending, receiving, analyzing, and/or presenting digital media, which can include a single and/or still image (e.g., a picture), multiple images or frames that collectively form a video, audio recordings, and/or any combinations thereof. In some implementations, a “media stream” can be sent, received, analyzed, and/or presented as continuous recording(s) of video and/or audio, which can include any number of individual frames, still images, audio tracks, and/or the like, which collectively form the “media stream.” While references may be made herein to either an “image,” a “video,” an “audio recording,” and/or the like, it should be understood that such a reference is not to the exclusion of other forms of media that may otherwise be included in the media stream, unless the context clearly states otherwise. In other words, any of the apparatus, systems, and/or methods described herein relate, in general, to digital media and reference to a specific type of digital media is not intended to be exclusive unless expressly provided.

The embodiments and methods described herein can include and/or can employ any suitable media capture devices or systems. In this context, a “media capture device” or a “device of a media capture system” can refer to any suitable device that is capable of capturing a picture, recording a video, recording audio, and/or combinations thereof. For simplicity, such devices are collectively referred to herein as “cameras.” It should be understood, however, that the term “camera” is intended to refer to a broad category of audio and/or image capturing/recording devices and should not be construed as being limited to any particular implementation unless the context expressly states otherwise.

The embodiments and methods described herein can provide a media stream associated with an event occurring at a venue including one or more virtual attendees or audience members. As used herein “virtual attendees” and/or “virtual audience members” can be used interchangeably or collectively to refer to at least one person (e.g., a viewer or an audience member) that is using an electronic device (e.g., a user device) to remotely participate in the event. That is to say, a “virtual audience” can include virtual audience members that are viewing, participating in, and/or otherwise engaging with a live event without being physically present at the event. By way of example, a virtual audience of a live event can include people watching (and/or listening to) the event via a television broadcast, radio broadcast, on-demand media stream, media over Internet Protocol (MoIP), and/or any other suitable mode of providing media content. The media content can be presented to the virtual audience member via any suitable electronic and/or user device, such as those described herein.

In some implementations, “virtual attendees” described herein can participate and/or engage in the live event (as opposed to a person simply watching or listening to the live event) by streaming from a user device media content associated with, representing, and/or depicting the virtual attendee watching or listening to the live event. In turn, the embodiments and/or methods described herein can be configured to present at least a portion of the media content associated with the virtual attendee on one or more displays, screens (e.g., green screens), monitors, etc., at the venue where the live event is taking place. As described in further detail herein, in some instances, the media stream associated with the live event can include images, video, and/or audio of the event and/or the media content associated with one or more virtual attendee(s) that is/are presented on the displays, screens, monitors, etc., at the venue. As such, a virtual attendee or virtual audience member can remotely participate and/or engage in the live event without being physically present at the venue.

In some implementations, the embodiments and methods described herein can use facial recognition analysis to identify one or more people in one or more images, videos, and/or media streams. As used herein, “facial recognition analysis” - or simply, “facial recognition” -generally involves analyzing one or more images of a person’s face to determine, for example, salient facial structure features (e.g., cheekbones, chin, ears, eyes, jaw, nose, hairline, etc.) and then defining a qualitative and/or quantitative data set associated with and/or otherwise representing the salient features. Facial recognition techniques in example embodiments may be alternatively referred to as facial matching or facial verification. One approach, for example, includes extracting data associated with salient features of a person’s face and defining a data set including geometric and/or coordinate based information (e.g., a three-dimensional (3-D) analysis of facial recognition and/or facial image data). Another approach, for example, includes distilling image data into qualitative values and comparing those values to templates or the like (e.g., a two-dimensional (2-D) analysis of facial recognition and/or facial image data). In some implementations, an approach to facial recognition can include any suitable combination of 3-D analytics and 2-D analytics.

Example facial recognition methods and/or algorithms include, without limitation, Principal Component Analysis using Eigenfaces (e.g., Eigenvector associated with facial recognition), Linear Discriminate Analysis, Elastic Bunch Graph Matching using the Fisherface algorithm, Hidden Markov model, Multilinear Subspace Learning using tensor representation, neuronal motivated dynamic link matching, convolutional neural networks (CNN), or a combination of two or more of these. Any of the embodiments and/or methods described herein can use and/or implement any suitable facial recognition method and/or algorithm or combination thereof such as those described above.

In some instances, facial recognition analysis can result in a positive identification of facial image data in one or more images and/or video streams when the result of the analysis satisfies at least one criterion. In some instances, the criterion can be associated with a minimum confidence score or level and/or matching threshold, represented in any suitable manner (e.g., a value such as a decimal, a percentage, or a combination of these). For example, in some instances, the criterion can be a threshold value or the like such as a 70% match of the image data to facial image data (e.g., stored in a database), a 75% match of the image data to the facial image data, a 80% match of the image data to the facial image data, a 85% match of the image data to the facial image data, a 90% match of the image data to the facial image data, a 95% match of the image data to the facial image data, a 97.5% match of the image data to the facial image data, a 99% match of the image data to the facial image data, or any percentage in a range between 70% and 99%.

In some implementations, facial recognition is performed to identify a match between an individual in two images (e.g., a reference image and a second image) without identifying an identity of an individual (or other personal information about the individual) in the images. For example, by performing facial recognition, a match between an individual in two images can be identified without knowing and/or identifying personally identifiable information about the individual. In some implementations, facial recognition can be used to identify a subset of information about the individual (e.g., a distribution method such as a phone number or email address, a profile including user-provided information, and/or the like). In some implementations, facial recognition can be between facial data associated with an individual (e.g., a faceprint of the individual, data associated with facial characteristics of the individual, etc.) and an image potentially including the individual regardless of whether additional data about the individual and/or an identity of the individual is identified. In other embodiments, facial recognition is performed to identify and/or verify an identity of one or more people in an image potentially including the individual.

In some implementations, the embodiments and methods described herein can use audio analysis to identify a match between, for example, a voice in two audio recording with or without identifying an identity of an individual in the audio recordings. In some implementations, audio analysis can be performed independently or in conjunction with facial recognition analysis, image analysis, and/or any other suitable analysis. As described above with reference to facial recognition analysis, audio analysis can result in a positive identification of audio data in one or more audio recordings and/or media streams when the result of the analysis satisfies at least one criterion. In some implementations, results of audio analysis can be used to increase or decrease a confidence level associated with the results of a facial recognition analysis and vice versa.

In some implementations, the embodiments and/or methods described herein can analyze any suitable data (e.g., contextual data) in addition or as an alternative to analyzing the facial image data and/or audio data, for example, to enhance an accuracy of the confidence level and/or level of matching resulting from the facial recognition analysis. For example, in some instances, a confidence level and/or a level of matching can be adjusted based on analyzing contextual data associated with any suitable metadata, address, source, activity, location, Internet Protocol (IP) address, Internet Service Provider (ISP), account login data, pattern, purchase, ticket sale, social media post, social media comments, social media likes, web browsing data, preference data, personally identifying data (e.g., age, race, marital status, etc.), data transfer rate, network connection modality, and/or any other suitable data. In some instances, a confidence level can be increased when the contextual data supports the result of the facial recognition analysis and can be decreased when the contextual data does not support and/or contradicts the result of the facial recognition analysis. Accordingly, non-facial recognition data can be used to corroborate the facial recognition data and/or increase/decrease a confidence score and/or level.

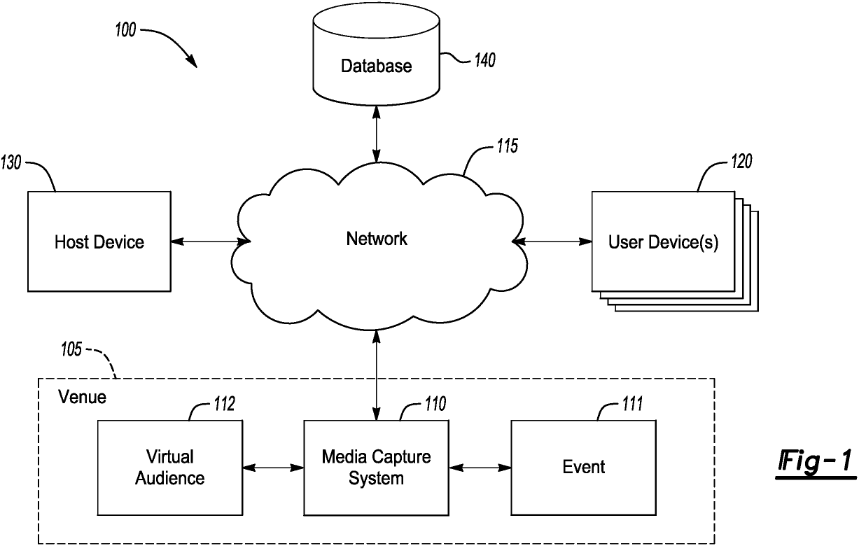

FIG. 1 is a schematic illustration of a virtual engagement system 100 according to an example embodiment. At least a portion of the system 100 can be, for example, represented and/or described by a set of instructions or code stored in a memory and executed in a processor of one or more electronic devices (e.g., a host device, a server or group of servers, a personal computer (PC), a network device, a user device, a client device, and/or the like). In some implementations, the system 100 can be used to present media (e.g., pictures, video recordings, and/or audio recordings) of a live event occurring at a venue that includes virtual attendees and/or a virtual audience.

The system 100 includes a host device 130 in communication with a database 140, one or more user device(s) 120, and a media capture system 110. The host device 130 can be any suitable host device and/or compute device such as a server or group of servers, a network management device, a personal computer (PC), a processing unit, and/or the like in electronic communication with the database 140, the user device(s) 120 , and the media capture system 110. For example, in this embodiment, the host device 130 can be a server or group of servers (disposed in substantially the same location and/or facility or distributed in more than one location) in electronic communication with the database 140, the user device(s) 120, and the media capture system 110 via a network 115.

As shown in FIG. 1, the media capture system 110 can be a media capture system of or at a venue 105. The venue 105 can be any suitable location, establishment, place of business, etc. For example, in some instances, the venue 105 can be an arena, a theme park, a theater, a studio, a hall, an amphitheater, an auditorium, a sport(s) complex or facility, a home, and/or any other suitable venue. In some instances, the venue 105 can be any suitable venue at which an event 111 is occurring. The event 111 can be a live event such as, for example, a sporting event, a concert, a wedding, a party, a graduation, a televised or broadcasted live show (e.g., a sitcom, a game show, a talk show, etc.), a political campaign event or debate, and/or any other suitable event.

In general, the event 111 can be a live event that is typically performed at the venue 105 in front of an audience that is present at the venue 105, allowing the audience members to participate in and/or engage the live event 111. In the embodiments described herein, at least a portion of the audience at the venue 105 can be a virtual audience 112. That is to say, at least a portion of the audience participating and/or engaging in the live event 111 can be a digital representation of one or more audience members (e.g., “virtual audience members”) who is/are not physically present at the venue 105. In some instances, all members of the audience are members of the virtual audience 112 (e.g., an event occurring in front of the virtual audience 112 with no audience members being physically present at the venue 105).

In general, references to “the audience” herein are references to the virtual audience 112 unless the context clearly states otherwise. It should be understood, however, that an audience of the event 111 can be entirely composed of the virtual audience 112 or can be composed of any suitable combination or mix of the virtual audience 112 and a live audience (e.g., audience members who are physically present at the venue). In some implementations including a combination of virtual and live audience members, the overall audience can be split or separated into, for example, a first section or first set of sections including members of the live audience and a second section or second set of sections including members of the virtual audience 112.

At least a portion of the media capture system 110 is physically located at the venue 105. The media capture system 110 can be and/or can include any suitable device or devices configured to capture media data (e.g., data associated with one or more pictures or still images, one or more video recordings, one or more audio recordings, one or more sound or visual effects, one or more projected or computer-generated images, and/or any other suitable data or combinations thereof). For example, the media capture system 110 can be and/or can include one or more cameras and/or recording devices configured to capture an image (e.g., a photo) and/or record a video stream (e.g., including any number of images or frames, which may have associated or corresponding audio). The media capture system 110 can include one or more media capture devices that are autonomous, semi-autonomous, and/or manually (e.g., human) controlled. In some embodiments, the media capture system 110 can include multiple cameras in communication with a central computing device such as a server, a personal computer, a data storage device (e.g., a network attached storage (NAS) device, a database, etc.), and/or the like.

In some implementations, the devices of the media capture system 110 (collectively referred to herein as “cameras”) are configured to send media data to a central computing device (not shown in FIG. 1) via a wired or wireless connection, a port, a serial bus, a network, and/or the like, which in turn, can store the media data in a memory and/or other data storage device. In some implementations, the central computing device can be in communication with the host device 130 via the network 115 and can be configured to provide the media data to the host device 130 for further processing and/or broadcasting. Although shown in FIG. 1 as being in communication with the host device 130 via the network 115, in some embodiments, such a central computing device can be included in, a part of, and/or otherwise coupled to the host device 130. In some embodiments, the media capture system 110 can be in communication with the host device 130 via the network 115 without such a central computing device.

In some implementations, the media capture system 110 can be associated with the venue 105 and/or owned by the venue owner. In some implementations, the media capture system 110 can be used in or at the venue 105 but owned by a different entity (e.g., an entity licensed and/or otherwise authorized to use the media capture system 110 in or at the venue 105 such as, for example, a television camera at a sporting event). In some implementations, the media capture system 110 can include any number of user devices controlled by a user who is physically present at the venue 105 (e.g., a live audience member or attendee or an employee working at the venue 105). For example, the media capture system 110 can include user devices such as smartphones, tablets, etc., which can be used as cameras or recorders. In such implementations, at least some of the user devices can be in communication with the host device 130 and/or a central computing device associated with the venue 105 (e.g., as described above). As such, the media capture system 110 need not be associated with a particular event and/or venue.

The media capture system 110 is configured to capture media data associated with the venue 105, the event 111, and/or the virtual audience 112 (and/or live audience if present). In other words, the media capture system 110 can be configured to capture media data within a predetermined, known, and/or given context (e.g., the context of the venue 105, the event 111, and/or a specific occurrence during the event 111). Such media data can be referred to as “contextual media data”. As a non-limiting example, the host device 130 can receive media data from the media capture system 110 and contextual data” associated with the venue 105, the event 111, and/or any other suitable contextual data and/or metadata from any suitable data source and can associate the contextual data with, for example, the media data. In some implementations, the contextual data can be associated with a member of the virtual audience 112 and, for example, the host device 130 can associate the contextual data and/or media data with that audience member. In some instances, the host device 130 can be configured to define contextual media data specific to the associated audience member and can send the contextual media data to a user device associated with that audience member (e.g., a user device 120 associated with that audience member).

The network 115 can be any type of network or combination of networks such as, for example, a local area network (LAN), a wireless local area network (WLAN), a virtual network (e.g., a virtual local area network (VLAN)), a wide area network (WAN), a metropolitan area network (MAN), a worldwide interoperability for microwave access network (WiMAX), a telephone network (such as the Public Switched Telephone Network (PSTN) and/or a Public Land Mobile Network (PLMN)), an intranet, the Internet, an optical fiber (or fiber optic)-based network, a cellular network, and/or any other suitable network. The network 115 can be implemented as a wired and/or wireless network. By way of example, the network 115 can be implemented as a WLAN based on the Institute of Electrical and Electronics Engineers (IEEE) 802.11 standards also known as WiFi. Moreover, the network 115 can include a combination of networks of any type such as, for example, a LAN or WLAN and the Internet. In some implementations, communication (e.g., between the host device 130, the user device(s) 120, and/or the media capture system 110) can be established via the network 115 and any number of intermediate networks and/or alternate networks (not shown), which can be similar to or different from the network 115. As such, data can be sent to and/or received by devices, databases, systems, etc. using multiple communication modes (e.g., associated with any suitable network(s) such as those described above) that may or may not be transmitted using a common network. For example, in some implementations, the user device(s) 120 can be a mobile telephone (e.g., smartphone) connected to the host device 110 via a cellular network and the Internet (e.g., the network 115).

In some instances, the network 115 can facilitate, for example, a peer networking session or the like. In some instances, such peer networking sessions can be established on one or more public networks, private networks, and/or otherwise limited access networks. In such instances, the peer networking session can be established by, for example, user devices and/or any other suitable electronic device, each of which share a common characteristic or data set. For example, in some instances, a peer networking session can include any suitable user device or group of user devices that is/are receiving a media stream associated with the event 111 (e.g., a member or group of members of the virtual audience 112). In some instances, a peer networking session can be automatically or manually established based on data associated with, indicative of, and/or otherwise representing a connection between two or more users. In some instances, a peer networking session can be automatically established based on one or more users “checking-in” and/or otherwise registering as a member of the virtual audience 112. In some instances, a user of a user device 120 can “check-in” when a media stream associated with the event 111 is received by the user device 120, and/or the like. Moreover, the “check-in” can include identifying information such as, for example, geo-location data, date and time data, personal or user identification data, device data or metadata, etc.

In some instances, a user of a user device 120 can establish a peer networking session in response to receiving a notification that a person or people who share a connection with the user is/are also part of the virtual audience of the event 111. In some instances, a user (via a user device 120) can request to join a peer networking session and/or can receive (via the user device 120) an invitation to join a peer networking session and/or the like. In some instances, establishing a peer networking session can, for example, facilitate communication (e.g., group chat sessions or the like) and/or sharing of media data between the user devices 120 of the users included in the peer networking session.

Each user device 120 can be any suitable compute device such as a PC, a laptop, a convertible laptop, a tablet, a personal digital assistant (PDA), a smartphone, a wearable electronic device (e.g., a smart watch, etc.), a mobile device, and/or the like. In some implementations, the user devices 120 include consumer electronics. A discussion of one user device 120 is provided below. It should be understood, however, that the system 100 can include any number of user devices 120 that can be similar in at least form and/or function as the user device 120 described below.

As shown in FIG. 2, the user device 120 can include at least a memory 121, a processor 122, a communication interface 123, an output device 124, and one or more input devices 125. The memory 121, the processor 122, the communication interface 123, the output device 123, and the input device(s) 125 can be in communication, connected, and/or otherwise electrically coupled to each other such as to allow signals to be sent therebetween (e.g., via a system bus, electrical traces, electrical interconnects, and/or the like).

The memory 121 of the user device 120 can be a random access memory (RAM), a memory buffer, a hard drive, a read-only memory (ROM), an erasable programmable read-only memory (EPROM), an electrically erasable programmable read-only memory (EEPROM), a flash memory or other suitable solid state non-volatile computer storage medium, and/or the like. In some instances, the memory 121 includes a set of instructions or code (e.g., executed by the processor 122) used to perform one or more actions associated with, among other things, communicating with the network 115, executing one or more programs and/or applications, and/or one or more actions associated with capturing, sending, receiving, analyzing, and/or presenting media data.

The processor 122 can be any suitable processing device configured to run or execute a set of instructions or code (e.g., stored in the memory 121). For example, the processor 122 can be a general-purpose processor (GPP), a central processing unit (CPU), an accelerated processing unit (APU), a graphics processor unit (GPU), a field programmable gate array (FPGA), an Application Specific Integrated Circuit (ASIC), and/or the like. Such a processor 122 can run or execute a set of instructions or code stored in the memory 121 associated with using a PC application, a mobile application, an internet web browser, a cellular and/or wireless communication (via a network), and/or the like. In some instances, the processor 122 can execute a set of instructions or code stored in the memory 121 associated with transmitting signals and/or data between the user device 120 and the host device 130 via the network 115. Moreover, in some instances, the processor 122 can execute a set of instructions received from the host device 130 associated with providing to the user of the user device 120 any suitable information associated with sending, receiving, and/or presenting media data, as described in further detail herein. In some implementations, at least the memory 121 and the processor 122 can be included in and/or can form at least a portion of a System on Chip (SoC) integrated circuit.

The communication interface 123 of the user device 120 can be any suitable module, component, engine, and/or device that can place the user device 120 in communication with the network 115 such as one or more network interface cards and/or the like. Such a network interface card can include, for example, an Ethernet port, a universal serial bus (USB) port, a WiFi ® radio, a Bluetooth ® radio, an NFC radio, a cellular radio, and/or the like. Moreover, the communication interface 123 can be electrically connected to the memory 121 and the processor 122 (e.g., via a system bus and/or the like). As such, the communication interface 123 can send signals to and/or receive signals from the processor 122 associated with electronically communicating with the network 115. Thus, the communication interface 123 can allow the user device 120 to communicate with the host device 130, one or more other user devices 120, and/or the media capture system 110 via the network 115.

The output device 124 of the user device 120 can be any suitable device configured to provide an output resulting from one or more processes being performed on or by the user device 120. For example, in some implementations, the output device 124 is a display such as, for example, a cathode ray tube (CRT) monitor, a liquid crystal display (LCD) monitor, a light emitting diode (LED) monitor, and/or the like that can visually represent data and/or any suitable portion of the system 100. In some implementations, the processor 122 can execute a set of instructions to cause the display to visually represent media data, a graphical user interface (GUI) associated with a webpage, PC application, mobile application, and/or the like. For example, in some instances, the display can graphically represent a PC or mobile application, which in turn, presents media data (e.g., a media stream) received via the network 115 (e.g., from the host device 130 and/or the media capture system 110). Portions of the system 100 can be implemented as a standalone application that is, for example, stored in the memory 121 and executed in the processor 122 or can be embedded (e.g., by way of a software development kit (SDK)) in an application provided by a specific broadcaster (e.g., the broadcaster that is providing and/or broadcasting the media stream captured by the media capture system 110).

In some implementations, the output device 124 can be a display that includes a touch screen configured to receive a tactile and/or haptic tactile user input. In some instances, such a display can be configured to graphically represent data associated with any suitable PC application, mobile application, imaging and/or recording device, and/or one or more notifications that may or may not be associated with a PC or mobile application. In other implementations, the output device 124 can be configured to provide any suitable output such as, for example, an audio output, a tactile or haptic output, a light output, and/or any other suitable output.

The input device(s) 125 of the user device 120 can be any suitable module, component, and/or device that can receive, capture, and/or record one or more inputs (e.g., user inputs) and that can send signals to and/or receive signals from the processor 122 associated with the one or more inputs. In some implementations, the input device(s) can be and/or can include ports, plugs, and/or other interfaces configured to be placed in electronic communication with a device. For example, such an input device 125 can be a USB port, an Institute of Electrical and Electronics Engineers (IEEE) 1394 (FireWire) port, a Thunderbolt port, a Lightning port, and/or the like. In some implementations, a touch screen or the like of a display (e.g., the output device 124) can be an input device 125 configured to receive a tactile and/or haptic user input.

In some implementations, an input device 125 can be a camera and/or other recording device capable of capturing and/or recording media data such as images, video recordings, audio recordings, and/or the like (referred to generally as a “camera”). For example, in some embodiments, such a camera 125 can be integrated into the user device 120 (e.g., as in smartphones, tablets, laptops, etc.) and/or can be in communication with the user device 120 via a port or the like (e.g., such as those described above). The camera 125 can be any suitable device such as, for example, a webcam, a forward or rearward facing camera included in a smartphone or tablet, and/or any other suitable camera. In some implementations, the camera can include and/or can function in conjunction with one or more microphones (i.e., other input devices 125) of the user device 120. In this manner, the camera (and microphone(s)) can capture media data of a given field of view. In some implementations, the input device 125 can be a webcam and/or a forward facing camera of a smartphone, tablet, laptop, wearable electronic device, etc. that can allow the user of the user device 120 to capture digital media (e.g., a picture, video, and/or audio recording) of himself or herself via the camera. In some implementations, the output device 124 (e.g., a display) can be configured to graphically represent the media data of the field of view captured by the camera (and microphone(s)).

In some implementations, an image of the user’s face (e.g., a “selfie”) can be used to register facial recognition data associated with the user of the user device 120 in or with the system 100. For example, once the camera captures a desired image, the processor 122 can receive and/or retrieve data associated with the image of the user’s face and, in turn, can execute a set of instructions or code (e.g., stored in the memory 121) associated with at least a portion of a facial recognition analysis. In some instances, the processor 122 can execute a set of instructions or code associated with verifying an alignment between the indication, frame, boundary, etc. graphically rendered on the display and the captured image of the user’s face. In some instances, the user device 120 can be configured to send, via the network 115, a signal associated with the media data of the user and/or the facial recognition data to the host device 130, which in turn, can perform any additional facial recognition analyses and/or can store the media data and/or the facial recognition data in a user-profile data structure stored in a memory and/or the database 140.

In some instances, the user device 120 can receive a media stream via the network 115. The user device 120, in turn, can visually represent the media stream to the user via the output device 124 (e.g., the display). In addition, the camera or input device 125 can be configured to capture a continuous stream of media that can, among other things, depict the user of the user device 120 as he or she watches (and/or listens to) the media stream graphically represented on the display. Furthermore, the user device 120 can be configured to send the media stream captured by the camera to the host device 130 via the network 115. The host device 130, in turn, can be configured to receive the media stream from the user device 120 and upon receipt can perform one or more processes associated with processing, analyzing, modifying, cropping, compressing, aggregating, and/or presenting the media stream from the user device 120, as described in further detail herein. In this manner, the user of the user device 120 can be a member of the virtual audience 112 of the event 111. Similarly, the system 100 can include any number of user devices 120, the users of which can collectively form the virtual audience 112 of the event 111.

Returning to FIG. 1, the host device 130 can be any suitable compute device configured, among other things, to send data to and/or receive data from the database 140, the user devices 120, and/or the media capture system 110, via the network 115. In some implementations, the host device 130 can function as, for example, a PC, a workstation, a server device (e.g., a web server device), a network management device, an administrator device, and/or so forth. In some embodiments, the host device 130 can be a group of servers or devices housed together in or on the same blade, rack, and/or facility or distributed in or on multiple blades, racks, and/or facilities.

In some implementations, the host device 130 can be a physical machine (e.g., a server or group of servers) that includes and/or provides a virtual machine, virtual private server, and/or the like that is executed and/or run as an instance or guest on the physical machine, server, or group of servers (e.g., the host device). In some implementations, at least a portion of the functions of the system 100 and/or host device 130 described herein can be stored, run, executed, and/or otherwise deployed in a virtual machine, virtual private server, and/or cloud-computing environment. Such a virtual machine, virtual private server, and/or cloud-based implementation can be similar in at least form and/or function to a physical machine. Thus, the host device 130 can be one or more physical machine(s) with hardware configured to (1) execute one or more processes associated with the host device 130 or (2) execute and/or provide a virtual machine that in turn executes the one or more processes associated with the host device 130. Similarly stated, the host device 130 may be a physical machine configured to perform any of the processes, functions, and/or methods described herein whether executed directly by the physical machine or executed by a virtual machine implemented on the physical host device 130.

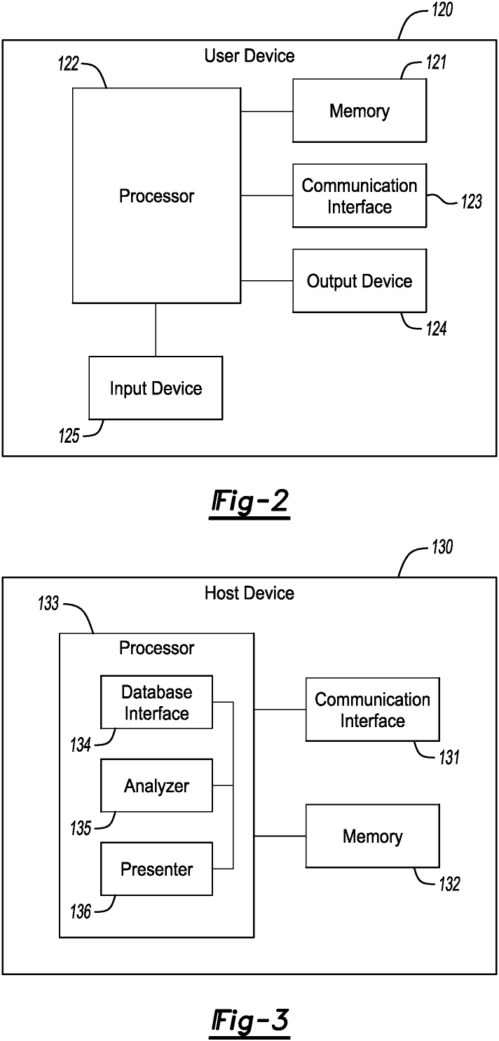

As shown in FIG. 3, the host device 130 includes at least a memory 132, a processor 133, and a communication interface 131. In some instances, the memory 132, the processor 133, and the communication interface 131 are in communication, connected, and/or otherwise electrically coupled to each other such as to allow signals to be sent therebetween (e.g., via a system bus, electrical traces, electrical interconnects, and/or the like). The host device 130 can also include and/or can otherwise be operably coupled to the database 140 (shown in FIG. 1) configured to store user data, facial data, contextual data (e.g., associated with a time, location, venue, event, etc.), media streams, and/or the like.

The communication interface 131 can be any suitable hardware-based and/or software-based device(s) (executed by the processor 133) that can place the host device 130 in communication with the database 140, the user device(s) 120, and/or the image capture device 160 via the network 105. In some implementations, the communication interface 131 can further be configured to communicate via the network 105 and/or any other network with any other suitable device and/or service configured to gather and/or at least temporarily store data such as user data, media data (e.g., image data, video data, and/or audio data), facial recognition data, notification data, and/or the like. In some implementations, the communication interface 131 can include one or more wired and/or wireless interfaces, such as, for example, network interface cards (NIC), Ethernet interfaces, optical carrier (OC) interfaces, asynchronous transfer mode (ATM) interfaces, and/or wireless interfaces (e.g., a WiFi® radio, a Bluetooth® radio, a near field communication (NFC) radio, and/or the like). As such, the communication interface 131 can be configured to send signals between the memory 132 and/or processor 133, and the network 105, as described in further detail herein.

The memory 132 of the host device 130 can be, for example, a RAM, a ROM, an EPROM, an EEPROM, a memory buffer, a hard drive, a flash memory and/or any other solid state non-volatile computer storage medium, and/or the like. In some instances, the memory 132 includes a set of instructions or code (e.g., executed by the processor 133) used to perform one or more actions associated with, among other things, communicating with the network 105 and/or one or more actions associated with receiving, sending, processing, analyzing, modifying, cropping, compressing, aggregating, and/or presenting media data (e.g., received from the media capture system 110 and/or one or more user devices 120.

The processor 133 of the host device 130 can be any suitable processor such as, for example, a GPP, a CPU, an APU, a GPU, a network processor, a front end processor, an FPGA, an ASIC, and/or the like. The processor 133 is configured to perform and/or execute a set of instructions, modules, and/or code stored in the memory 132. For example, the processor 133 can be configured to execute a set of instructions and/or modules associated with, among other things, communicating with the network 105; receiving, sending, processing, analyzing, modifying, cropping, compressing, aggregating, and/or presenting media data; and/or registering, defining, storing, and/or sending image data, facial recognition data, and/or any other suitable media data.

The database 140 (referring back to FIG. 1) associated with the host device 130 can be any suitable database such as, for example, a relational database, an object database, an object-relational database, a hierarchical database, a network database, an entity-relationship database, a structured query language (SQL) database, an extensible markup language (XML) database, a digital repository, a media library, a cloud server or storage, and/or the like. In some implementations, the database 140 can be a searchable database and/or repository. In some implementations, the database 140 can be and/or can include a relational database, in which data can be stored, for example, in tables, matrices, vectors, etc. according to the relational model.

In some implementations, the host device 130 can be in communication with the database 140 over any suitable network (e.g., the network 115) via the communication interface 131. In such implementations, the database 140 can be included in or stored by a network attached storage (NAS) device that can communicate with the host device 130 over the network 115 and/or any other network(s). In some implementations, the database 140 can be stored in the memory 132 of the host device 130. In some implementations, the database 140 can be operably coupled to the host device 130 via a cable, a bus, a server rack, and/or the like.

The database 140 can store and/or at least temporarily retain data associated with the virtual engagement system 100. For example, in some instances, the database 140 can store data associated with and/or otherwise representing user profiles, resource lists, facial recognition data, contextual data (e.g., associated with a time, a location, the venue 105, the event 111, the virtual audience 112, etc.), media data (e.g., video streams or portions of video streams, images, audio recordings, and/or the like), audio recognition data (e.g., an audio recording of the user), signed releases and/or consent associated with users, user preferences (e.g., favorite sports, favorite teams, virtual seat preference for a venue, etc.), and/or the like. In some instances, the database 140 can store data associated with users who have registered with the system 100 (e.g., “registered users”). In some such instances, a registration process can include a user providing the system 100 (e.g., the host device 130) with facial image data, contextual data, user preferences, user settings, personally identifying data, signed releases, consent and/or agreement of terms, and/or any other suitable data. In response, a user profile data structure can be defined in the database 140 and the data can be stored in and/or associated with that user profile data structure.

In some implementations, the host device 130 can be configured to associate the registered user with a specific event (e.g., the event 111) and/or a specific venue (e.g., the venue 105). As another example, in some instances, the host device 130 can be configured to store in the database 140 media data and/or media stream data received from a video or image source (e.g., the media capture system 110) and contextual data associated with the video stream data. In some instances, the media data and/or the media stream data and the contextual data associated therewith can collectively define a contextual media stream or the like, as described in further detail herein. In some instances, the media stream data can be stored in the database 140 without contextual data or the like. In some instances, the contextual data and/or any other relationships or associations between data sets in the database 140 can be used to reduce false positives associated with one or more facial recognition processes, audio processes, and/or other analytic processes.

In some implementations, the user profiles can be user profile data structures that include information relating to users accessing and/or providing media data. For example, a user profile data structure can include a user profile identifier, facial data (e.g., data obtained from an image of the user (e.g., facial characteristic data) that can be used to match the user to an image from the media data), a list of identifiers associated with media data structures stored in the database 140 and associated with the user or user device 120, a list of identifiers associated with the user profile data structures of other users with which the user is associated (e.g., as a friend and/or contact), user location data, signed release data, user preferences, and/or the like.

In some implementations, users can add each other as friends within an application through which they access media data. Users also can be automatically associated with each other (e.g., when a user associated with a first user profile is a contact of another user associated with a second user profile). For example, a user operating a user device 120 can have a list of contacts, and/or other contact information, stored at the user device 120. The application can retrieve and import the contact information, can match the contact information to information in at least one user profile in the database 140, and can automatically associate that at least one user profile with that user.

In some implementations, the users can be associated with each other by storing a list of friends and/or contacts (e.g., a list of identifiers of user profiles to be added as friends of a particular user) within each user profile of each user. When a user adds a friend and/or contact, the user automatically can be notified when the friend and/or contact is a member of the virtual audience 112 of the same event 111, and/or when the friend and/or contact records and/or receives media data, video stream data, user-specific contextual media data, and/or the like. In some implementations, the host device 130 also can use the stored relationships between users to automatically process media data associated with the user (e.g., to determine whether friends and/or contacts of the user can be found within the media data). For example, when the media data is received, when a friend and/or contact is associated with the user, the host device 130 automatically can process the media data to determine whether facial data associated with the friends and/or contacts of the user can be matched to the media data. In some instances, when a friend and/or contact of the user is matched to the media data, the host device 130 automatically can associate the friend and/or contact with the user. In some instances, the host device 130 can provide the user (e.g., via the user device 120) with a notification associated with and/or indicative of the match. In some instances, the host device 130 can provide the user (e.g., via the user device 120) with an instance of the media data in response to a match. In some instances, the host device 130 can present the media data associated with the friend and/or contact in a virtual audience specific to the user.

Although the host device 130 is schematically shown and described with reference to FIG. 1 as including and/or otherwise being operably coupled to the database 140, in some embodiments, the database 140 is maintained on multiple devices that may be in multiple locations or the host device 130 can be operably coupled to any number of databases. Such databases can be configured to store at least a portion of a data set associated with the system 100. For example, in some embodiments, the host device 130 can be operably coupled to and/or otherwise in communication with a first database configured to receive and at least temporarily store user data, user profiles, and/or the like and a second database configured to receive and at least temporarily store media data and/or video stream data and contextual data associated with the media data and/or video stream data. In some embodiments, the host device 130 can be operably coupled to and/or otherwise in communication with a database that is stored in or on the user device 120 and/or the media capture system 110. Similarly stated, at least a portion of a database can be implemented in and/or stored by the user device(s) 120 and/or the media capture system 110. In this manner, the host device 130 and, in some instances, the database 140 can be in communication with any number of databases that can be physically disposed in a different location than the host device 130, while being in communication with the host device 130 (e.g., via the network 115).

In some instances, the user can search the database 140 to retrieve and/or view media data (e.g., contextual media data) associated with the users that have profiles stored in the database 140. In some instances, the user can have limited access and/or privileges to update, edit, delete, and/or add media data associated with his or her user profile (e.g., user-specific contextual media data and/or the like). In some instances, the user can, for example, update and/or modify permissions associated with accessing the user-specific media data associated with that user; redistribute, share, and/or save media data and/or user-specific contextual media data (e.g., defined by the host device 130) associated with the user; block access to user-specific data; update user information and/or data such as favorite teams, family members, friends, rivals, etc.; allow other users to search for and/or identify the user in the virtual audience 112 (e.g., establish, modify, and/or remove privacy settings); update releases, consent and/or permission to display the user at an event; and/or the like.

Returning to FIG. 3, as described above, the processor 133 of the host device 130 can be configured to execute specific functions or instructions. The functions can be implemented in, for example, hardware, software stored in the memory 132 and/or executed in the processor 133,. For example, as shown in FIG. 3, the processor 133 includes a database interface 134 to execute database functions, an analyzer 135 to execute analysis functions, and a presenter 136 to execute presentation functions. The database interface 134, the analyzer 135, and the presenter 136 can be connected and/or electrically coupled. As such, signals can be sent between the database interface 134, the analyzer 135, and the presenter 136.

The database interface 134 includes and/or executes a set of instructions that is associated with monitoring, searching, and/or updating data stored in the database 140. For example, the database interface 134 can include and/or execute instructions to cause the processor 133 to store data in the database 140 and/or update data stored in the database 140 with data provided by the analyzer 135 and/or the like. In some instances, the database interface 134 can receive a signal indicative of an instruction to query the database 140 to (i) determine if the data stored in the database 140 and associated with, for example, a user matches any suitable portion of media data received, for example, from the media capture system 110 and (ii) update the data stored in the database 140 in response to a positive match. If, however, there is not a match, the database interface 134 can, for example, query the database 140 for the next entry (e.g., data associated with the next user) and/or can otherwise not update the database 140. Moreover, the database interface 134 can be configured to store the data in the database 140 in a relational-based manner and/or in any other suitable manner.

The analyzer 135 includes and/or executes a set of instructions that is associated with receiving, collecting, and/or providing media data associated with the event 111. More particularly, the analyzer 135 can receive data (e.g., from the communication interface 131), such as data associated with a user (e.g., facial recognition information, profile information, preferences, activity logs, location information, contact information, calendar information, social media activity information, image analytics, etc.), a venue (e.g., location data, resource data, event schedule), or an event. The analyzer 135 can receive a signal from the communication interface 131 associated with a request and/or an instruction to perform and/or execute any number of processes associated with analyzing media data received from one or more user device 120.

In some instances, the analyzer 135 can receive data from the communication interface 131 in substantially real-time. That is to say, in some instances, a user device 120 can be in communication with the host device 130 via the network 115 and can send a substantially continuous stream of media data captured by an input device (e.g., camera) of the user device 120. In response, the analyzer 135 can receive the stream of media data (e.g., via the communication interface 131) and can perform one or more processes associated with analyzing the media data. In some instances, the analyzer 135 can be configured to perform any suitable analysis to confirm that the media data has a desired (e.g., standardized) format, size, resolution, bitrate, etc. In some instances, the analyzer 135 can be configured to perform image analysis, facial recognition analysis, audio analysis, and/or any other suitable analysis on the media data (e.g., an analysis of data and/or metadata associated with a location, an IP address, an ISP, a user account, and/or the like). In some instances, the processor 122 of the user device 120 can perform an initial analysis of the media data and the analyzer 135 can be configured to verify the results of the analysis performed by the processor 122 of the user device 120 (e.g., via a digital signature and/or the like). In some instances, such an implementation can, for example, reduce latency, resource usage, overhead, and/or the like.

In some instances, the analyzer 135 can be configured to analyze an initial portion of a stream of media data received from a user device 120 to determine whether to allow a user depicted in the media data to be a member of the virtual audience 112. For example, the analysis of the initial portion of the media data can include analyzing contextual data and/or metadata associated with the media stream, the user device 120, and/or the user. In some implementations, the analyzer 135 can review and/or verify login or account information, location information, IP address information, updated signed waivers and/or approvals, etc., and/or can perform facial recognition analysis, image analysis (e.g., to determine a presence of an individual), audio analysis, and/or the like on the initial portion of the media data to identify one or more persons depicted in the media data and/or to verify the person depicted in the media data is an authorized user of the user device 120 and/or has given appropriate consent and/or signed the appropriate waivers and/or documents. In some instances, the analysis of the media data can confirm that a person is depicted in the media data (e.g., a person is within the field of view of the camera of the user device 120). In some instances, the analysis of the media data can identify and/or confirm the identity of the user depicted in the media data (e.g., via facial recognition, audio or voice recognition, and/or the like). In some instances, the analysis of the media data can be used to confirm the content depicted in the media data is appropriate for the event 111. For example, a user wearing face paint in support of his or her favorite basketball team may be appropriate when the event 111 is a basketball game but may not be appropriate when the event 111 is a political debate. Similarly, the analysis (e.g., facial recognition analysis, image analysis, audio analysis, etc.) of the media data can be used to filter and/or remove media data (e.g., an image or images, audio, etc.) with content that may be indecent, inappropriate, explicit, profane, and/or age restricted.

In some instances, the analyzer 135 can be configured to verify, register, and/or allow a user to be a member of the virtual audience 112 when the result of the analysis satisfies a criterion such as, for example, a confidence level and/or matching threshold, represented in any suitable manner (e.g., a value such as a decimal, a percentage, and/or the like). For example, in some instances, the criterion can be a threshold value or the like such as a 70% match of the media data and at least a portion of the data stored in the database 140, a 75% match of the media data and at least a portion of the data stored in the database 140, a 80% match of the video image and at least a portion of the data stored in the database 140, a 85% match of the media data and at least a portion of the data stored in the database 140, a 90% match of the media data and at least a portion of the data stored in the database 140, a 95% match of the media data and at least a portion of the data stored in the database 140, a 97.5% match of the media data and at least a portion of the data stored in the database 140, a 99% match of the media data and at least a portion of the data stored in the database 140, or any percentage therebetween.

In some instances, when determining whether to allow a user to be part of the virtual audience, the analyzer 135 can analyze and/or review whether the user has given appropriate consent and/or signed the appropriate waivers and/or documents. In such instances, the analyzer 135 can review the user’s profile to determine whether the user’s profile has up-to-date signed and/or agreed to waivers and/or consent agreements. In some implementations, the analyzer 135 can identify the user’s profile based on the login information provided by the user and/or the user device 120 being associated with the user. In some implementations, the analyzer 135 can identify the user’s profile by performing facial recognition on the person depicted in the media data to identify an identity of the person. The analyzer 135 can then review the profile associated with the person identified in the media data to determine if that person has given appropriate consent and/or signed the appropriate waivers and/or documents. Using facial recognition to identify the user actually depicted in the media data (rather than merely relying on the user account and/or an association with the user device 120) can ensure that each user actually depicted in the media data has provided the appropriate consent to be part of the virtual audience. For example, if multiple individuals are using the same compute device, the analyzer 135 can ensure that each of the individuals has provided appropriate consent. For another example, if a family member of a user appears in the media data from the user device associated with the user, the analyzer 135 can ensure that the family member has provided the appropriate consent. In some implementations, if an individual is detected that has not yet provided the appropriate consent, the analyzer 135 can send a request to the user device 120 for that individual to provide consent prior to joining the virtual audience. Moreover, in some implementations, if an individual is detected that has not yet provided the appropriate consent, the analyzer 135 can automatically (i.e., without producer input) prevent that user and/or user device from joining the virtual audience and/or remove that user and/or user device from the virtual audience.

In some instances, the analyzer 135 can be configured to establish a connection between the user device 120 and the host device 130 in response to the analyzer 135 identifying the user depicted in the media data and/or otherwise allowing the user depicted to become a member of the virtual audience 112. For example, in some instances, the analyzer 135 can send a signal to the communication interface 131 to establish a secure link, tunnel, and/or connection between the user device 120 and the host device 130 via the network 115.

In some instances, the analyzer 135 can define a user profile (e.g., as part of a user registration, as part of initially accessing the host device 130, and/or the like) or the like that includes the user’s media data (received from the user device 120), and any other suitable information or data associated with the user or user device 120 (e.g., contextual data) such as, for example, a picture, video recording and/or audio recording, personal and/or identifying information (e.g., name, age, sex, birthday, hobbies, marital status, profession, favorite sports teams, etc.), calendar information, contact information (e.g., associated with the user and/or the user’s friends, family, associates, etc.), device information (e.g., a media access control (MAC) address, Internet Protocol (IP) address, etc.), location information (e.g., current location data and/or historical location data), social media information (e.g., profile information, user name, password, friends or contacts lists, etc.), consent information (e.g., signed waivers, a consent to be included in a virtual audience, etc.) and/or any other suitable information or data. In some instances, the analyzer 135 can send a signal to the database interface 134 indicative of an instruction to store the user profile data in the database 140, as described in further detail herein. In some instances, the contextual data and/or at least a portion thereof can be used for filtering and/or searching for members of the virtual audience 112 having similar interests, characteristics, attributes, etc., as described in further detail herein.

While the analyzer 135 is described above as analyzing media data and/or contextual data received from one or more user devices (e.g., via facial recognition, audio recognition, and/or any other suitable analysis), in some implementations, the analyzer 135 is also configured to analyze media data and/or contextual data received from the media capture system 110. For example, in some instances, the event 111 can be a concert with a performer singing live at the venue 105. In some such instances, the analyzer 135 can analyze media data received from the media capture system 110 and, for example, can identify at least a portion of the audio data being that of the performer singing. In some implementations, the analyzer 135, in turn, can compare the audio data against audio data received from a user device 120 to confirm that the user is participating as a member of the virtual audience 112. Conversely, the analyzer 135 can compare the audio data of the performer singing against audio data received from a user device 120 to distinguish audio data of a user singing from the audio data of the performer singing.

In some instances, the host device 130 and/or the analyzer 135 can ensure that the audio data associated with the performer singing is presented at a desirable volume and/or otherwise is assigned a higher priority, preference, volume, bias, etc. (e.g., relative to other audio data). In some instances, the host device 130 and/or the analyzer 135 can ensure that the audio data associated with the user singing is not included in the media data provided to the users of other user devices 120 or one or more participants in the event 111, such as the performer, unless accepted, authorized, and/or otherwise permitted by the user singing and/or the user or event participant receiving the media data. In some instances, a separated, isolated, and/or individualized stream of audio data (e.g., associated with a member of the virtual audience 112) can be at least a part of user-specific contextual media data provided to the user. In some instances, a separated, isolated, and/or individualized stream of audio data can be productized, sold, and/or otherwise made available (e.g., to the public).

In some instances, the host device 130 and/or the analyzer 135 can perform audio recognition to ensure any users of the virtual audience are complying with rules and/or guidelines established for that virtual audience. If such a user is not complying with the rules and/or guidelines established for that virtual audience, the host device 130 (e.g., using the presenter 136) can automatically mute and/or remove that user from the virtual audience. For example, if the user is cussing and/or inappropriately heckling a performer, this can be identified by the analyzer 135 using audio recognition and the presenter 136 can mute and/or remove the user from the virtual audience. For another example, if the analyzer 135 identifies that the user’s microphone is picking-up loud and/or distracting noises in the background, the presenter 136 can mute and/or remove the user from the virtual audience. Moreover, audio recognition can be used to identify an identity of a user of the virtual audience. Such identification can be used to remove banned users (even if using a different user’s account), keep track of bad actors, determine whether that user has provided appropriate consent to be part of the virtual audience (and automatically prevent a user from participating in the virtual audience if they have not provided appropriate consent), and/or the like. Any suitable audio analysis can be used to perform the audio recognition. For example, natural language processing, machine learning, artificial intelligence and/or the like can be used to identify a user and/or what the user is saying.

In some instances, the analyzer 135 can be configured to match, synchronize, and/or otherwise associate at least a portion of the media data (and/or contextual data) received from one or more user devices 120 to the media data (and/or contextual data) received from the media capture system 110 at the venue 105. For example, the analyzer 135 can be configured to analyze and sync media data received from one or more user devices 120 with media data received from the media capture system 110 to ensure the media data substantially coincide (e.g., occur and/or capture data associated with substantially the same time).

In some implementations, the analyzer 135 is configured to include and/or execute a set of instructions that is associated with aggregating, combining, and/or synchronizing data (e.g., the media data). For example, in some implementations, the analyzer 135 can analyze media data received from a user device 120 and in response to allowing the user of the user device 120 to be a member of the virtual audience 112, the analyzer 135 can aggregate the media data from that user device 120 with the media data associated with other members of the virtual audience 112 (e.g., media data received from other user devices 120). In addition, the analyzer 135 can be configured to synchronize media data (e.g., temporally synchronize media data) received from any number of user devices 120 to ensure the media data substantially coincides (e.g., temporally). In some instances, the aggregation and synchronization of the media data from the user devices 120 can include aggregating and synchronizing video data and/or audio data. For example, in some instances, the audio data can be synchronized such that the recorded reactions (e.g., cheers, chants, laughs, applause, fist pumps, heckles, etc.) of the members of the virtual audience 112 correspond to an occurrence during the event 111 at substantially the same time (e.g., immediately following or nearly immediately following a team scoring a goal). Similarly, in some instances, the video data and/or images can be synchronized such that physical (non-auditory) reactions of the members of the virtual audience 112 correspond to the occurrence during the event 111 at substantially the same time. In some implementations, video data and/or image data of the virtual audience 112 (e.g., the entire virtual audience 112 or sections or portions thereof) can be aggregated and used to create, for example, a “crowd shot” or image. In some instances, the host device 130 (or portions thereof) can be configured to replace, overlay, augment, enhance, supplement, etc., stock video of an audience with the media data (e.g., video data) of the members of the virtual audience 112.

In some instances, once the analyzer 135 aggregates and/or synchronizes the media data received from the user devices 120 (e.g., the image data, video data, and/or audio data), the analyzer 135 can send a signal to the presenter 136 that is indicative of an instruction to present the media data. In some instances, the analyzer 135 can synchronize the audio recordings from the media data received from each user device 120 independent from the image and/or video data. In such instances, the analyzer 135 can aggregate and/or combine the audio recordings into a single audio track, which in turn, can be sent to the presenter 136 to be played at the venue 105 and/or to be sent, broadcast, and/or streamed to the user devices 120 and/or any other electronic devices configured to receive a broadcast (e.g., a television) along with video data captured by the media capture system 110.

The presenter 136 includes and/or executes a set of instructions that is associated with presenting the media data received from the user devices 120 at the venue 105. For example, in some implementations, the venue 105 can include one or more videoboards (e.g., displays) configured to digitally represent the media data in response to a signal and/or instruction received from the presenter 136. In some implementations, the venue 105 can include one or more screens (e.g., a “green screen”), which can allow the presenter 136 and/or other portion of the host device 130 to present the media data via chroma key compositing and/or other computer-generated imagery (cgi) techniques. In some implementations, the venue 105 can be configured to include only the virtual audience 112, with videoboards, “green screens,” screens on which an image can be displayed and/or projected, and/or the like substantially surrounding a court, stage, platform, etc., of the venue 105. In some implementations, the venue 105 can be configured to include a mix of the virtual audience 112 and a live audience that is physically present at the venue 105. In such implementations, the videoboards, screens (e.g., green screens and/or any suitable screen on which an image can be displayed and/or projected), and/or the like can be disposed in any suitable position and/or arrangement within the venue 105 (e.g., placed in specific rows or sections of an arena or theater, and/or the like).

The presentation of the media data at the venue 105 can be such that each user (or group of users) depicted in the media data received from a user device 120 becomes a member of the virtual audience 112 at the venue 105. In some instances, providing a presentation of the virtual audience 112 at the venue 105 can allow the virtual audience 112 to participate in and/or engage the event 111 (e.g., a live event) that is actually occurring at the venue 105 (e.g., in a manner similar to the participation and/or engagement of a member of a live audience physically present at the venue 105). Moreover, in some instances, providing a presentation of the virtual audience 112 at the venue 105 can allow the participants of the event 111 (e.g., athletes, graduates, celebrants, politicians, etc.) to see and/or hear the virtual audience 112 engaging the event 111 (e.g., cheering, fist pumping, booing, dancing, asking a question, etc.), which may have the potential to enhance or hinder the performance of the event participants (e.g., the athletes and/or the like).

The presenter 136 can be configured to present media data associated with any number of virtual audience members in any suitable manner. For example, in some implementations, the presenter 136 can be configured to present the media data and/or media streams in a grid of 2-D “tiles” and/or tiles arranged in a manner similar to a section of seats at an arena.

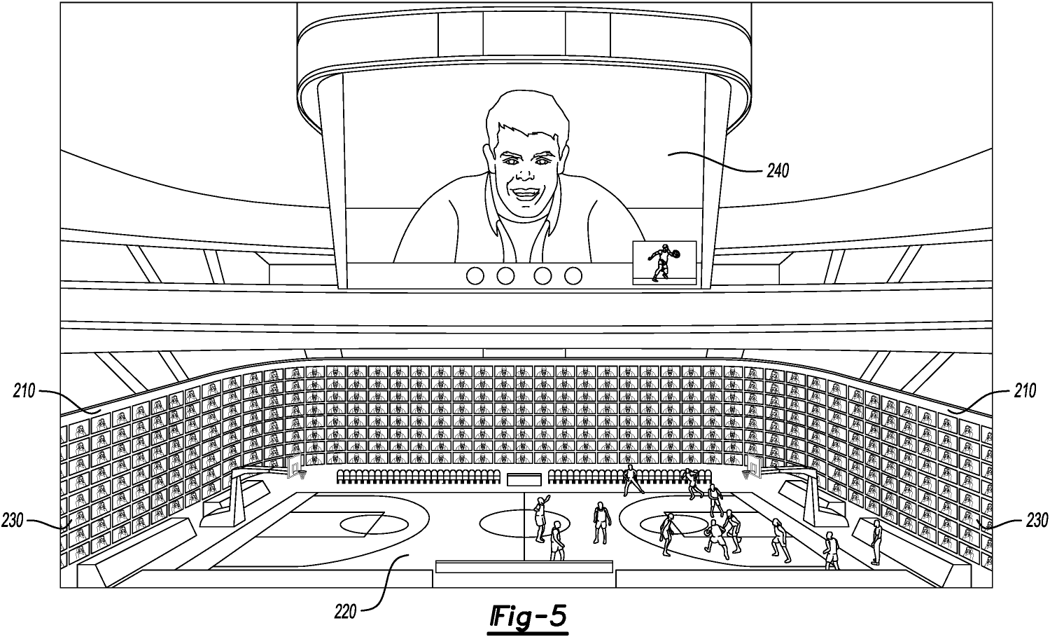

For example, FIG. 5 is an illustration of a venue with a virtual audience, according to an embodiment. As shown in FIG. 5, the venue has a screen 210 (e.g., a display, a screen on which an image can be displayed and/or projected, a green screen, a monitor and/or the like) near the playing surface 220 (e.g., near the basketball court in FIG. 5). Multiple tiles 230 of virtual audience members are displayed on the screen 210. The tiles 230 can show video of the virtual audience members as they are engaging (e.g., watching, cheering, booing, etc.) in the event. In some implementations, one or more virtual audience members can also be highlighted and/or featured on one or more additional screens 240 (e.g., a screen, videoboard, display, monitor, and/or the like such as those described herein) within the venue. While shown in FIG. 5 as being on three sides of a basketball court, in some implementations, the screen can surround the playing surface or other area in which a performance is being performed (e.g., court, stage, field, rink, etc.) or can be on one or more sides of the playing surface or other area in which a performance is being performed (e.g., court, stage, field, etc.). For example, in a baseball stadium the area in center field known as the “batter’s eye” may not have a screen. Moreover, while discussed herein as being a screen, such a screen can be any suitable display and/or number of screens and/or displays.

While shown as being a vertical screen (e.g., a screen such as any of those described herein), in some implementations the screen can be angled and/or tiered similar to stadium and/or inclined seating. In such implementations, for example, each successive row of tiles can appear to be behind the previous / lower row of tiles. In some implementations, the tiles can be different sizes on a vertical or non-vertical (e.g., angled or tiered) screen. For example, tiles lower on the screen and/or closer to the area in which a performance is being performed can be larger than tiles higher on the screen and/or further from the area in which the performance is being performed. Moreover, more tiles can be fit and/or displayed in rows higher on the screen and/or further from the area in which the performance is being performed than the rows lower on the screen and/or closer to the area in which the performance is being performed. This can provide an illusion and/or effect of depth similar to stadium and/or inclined seating.

Moreover, in some implementations, the tiles on the screen can be used to interact with virtual fans. For example, in such implementations a virtual audience on a screen (similar to that in FIG. 5) can be provided at a baseball stadium for a baseball game. If a player hits a homerun or foul ball that strikes a tile of the screen, the fan shown in that tile can be sent and/or provided the homerun or foul ball or other prize (e.g., gift card, congratulatory message, etc.). Similar situations can be provided at other sporting events, concerts, and/or the like. As other examples, a tennis ball (or other prize) can be sent and/or otherwise provided to a fan in a virtual audience at a tennis match when the ball strikes a tile on a screen showing that fan in the virtual audience, a hockey puck (or other prize) can be sent and/or otherwise provided to a fan in a virtual audience at a hockey game when the hockey puck strikes a tile on a screen showing that fan in the virtual audience, a guitar pick or drum stick can be sent and/or otherwise provided to a fan in a virtual audience at a concert when the guitar pick or drum stick strikes a tile on a screen showing that fan in the virtual audience, and/or the like. As another example, in some instances a cheerleader, a promoter, etc. can throw shirts (or other items) into the virtual crowd. If the shirt (or other item) strikes a tile of the screen, the fan shown in that tile can be sent and/or provided the shirt (or other item).

In some instances, an avatar or the like associated with the user depicted in the tile can be shown as catching the ball, puck, guitar pick, drum stick, etc. For example, a video of the avatar catching the ball, puck, guitar pick, drum stick, etc. can be presented on the additional screen 240, and/or any suitable portion of the screen 210. In some instances, a cheerleader (or other individual) can be shown to virtually throw shirts (or other items) into the virtual crowd (rather than physically being there). This can be done by the cheerleader (or other individual) randomly selecting fans to receive the shirts (or other items such as gift cards). A video simulating the cheerleader (or avatar of the cheerleader) throwing the shirts (or other items) and a fan (or avatar of the fan) catching the items can be shown.

In some implementations, the individual shown in a tile can see a video of the event from a perspective of where the tile is in the venue. For example, a separate camera can be provided for each section of an event and an individual with a tile in a certain section can view the event from that section as if they were sitting in that section. Thus, when an item comes towards that individual’s tile (e.g., a homerun ball), the individual in the tile can view the item coming towards them as if they were at the venue.

In some implementations, a replay can be provided for fans with tiles in a certain section of a virtual audience. For example, if a homerun ball strikes a tile of a virtual audience in a certain section of a stadium, a replay (e.g., a digitally modified replay) can be provided showing the fan in the tile catching the homerun ball and the fans in the tiles surrounding the tile the homerun ball struck almost catching the homerun ball. For another example, if a player dives into the stands (e.g., to catch a ball), a replay (e.g., a digitally modified replay) can be shown with the player interacting with the fans in the tiles as would occur were the fans in that section of the stadium. In some instances, such a replay can be modified to be from the perspective a fan would have from their respective tile as if they were in the arena (e.g., the fan sees the replay as if the homerun ball is coming at her). In some instances, the replay can be shown such that the tiles of fans are shown in the background and the individuals in such tiles can be seen in the background of the replay. Such replays can provide individuals the feeling of being at the event and in a particular section of the venue.

In some implementations, the player and/or performer can select one or more individuals from the virtual audience with whom to interact. For example, at a concert, a musician can select a tile from the virtual audience and the musician can engage in a conversation with the individual depicted in the tile (e.g., the audio associated with that tile is amplified over the audio from the remaining tiles). Similarly, the host of a talk show can select a tile from the virtual audience and the host can engage in a conversation with the individual depicted in the tile. In some instances, the tile associated with the virtual audience member with whom the player and/or performer is interacting can be presented, for example, on the additional screen 240. In some instances, for example, a player (or other participant) can select a tile from the virtual audience and can provide an autograph (e.g., on a baseball) while interacting with the individual depicted in the tile. The autograph (e.g., on the baseball) can then be sent or otherwise provided to the individual in that tile.

In some implementations, users can pay different prices to be presented in different sections and/or portions of the virtual audience. For example, a price for a user to have a tile presented in a first row of a virtual audience of a basketball game may be higher than a price for a user to have a tile presented in the last row of the virtual audience. Moreover, a user may want to pay a premium to have his tile presented in a likely homerun spot to hopefully obtain a homerun ball as discussed above. Accordingly, the price for being presented in the virtual audience can vary based on where the tile is presented with respect to the virtual audience in the venue.

Returning to FIG. 1, as described above, the media capture system 110 at the venue 105 can be used to capture media data associated with the event 111 as well as media data associated with the virtual audience 112 (and/or live audience if present at the venue 105). In some instances, one or more broadcast producers (e.g., users) can control the host device 130 to select and/or determine which members of the virtual audience 112 to present (e.g., via the presenter 136), which in turn, can be captured and/or depicted in the media data captured by the media capture system 110 at the venue 105. For example, the event 111 can be a basketball game and in response to the “home team” making a shot, the presenter 136 can receive an instruction (e.g., from a producer, from one or more users, from a participant in the event 111, from an automated classifier using analytics such as the analyzer 135 described herein, according to one or more criterion(ia), etc.) to present members of the virtual audience 112 who are fans of the home team and are cheering in response to the player making the shot. As described above, the host device 130 can receive data in addition to the media data from the user devices 120 (e.g., contextual data), which can be used to filter and/or search for specific members of the virtual audience 112. For example, such contextual data could include data indicating that a user is a fan of the home team playing the basketball game at the venue 105.

In some instances, the presenter 136 can present the members of the virtual audience 112 (e.g., as “tiles”) based on contextual data associated with the user of the corresponding user device 120. For example, in some instances, the presenter 136 can separate the virtual audience 112 into sections based on which team the user supports or favors. Specifically, the presenter 136 can arrange the tiles such that members of the virtual audience 112 supporting the “home team” are in a first section, while members of the virtual audience 112 supporting the “away team” are in a second section separate from the first section.

In some instances, the presenter 136 can present tiles showing members of the virtual audience 112 who are more responsive and/or reactive to the event 111 than other members. For example, in some instances, the analyzer 135 can perform facial recognition analytics (e.g., analyses), video analytics, image analytics, audio analytics, machine learning, artificial intelligence, and/or any other suitable analysis on the media data associated with a member of the virtual audience 112 to determine, identify, classify, etc., one or more characteristics of the user’s response and/or reaction. In some instances, the presenter 136 can be configured to increase a priority, bias, and/or weight associated with members of the virtual audience 112 who are more responsive and/or reactive to the event 111 (e.g., who the analyzer 135 determines are more responsive and/or reactive), which in turn, can increase a likelihood of that member of the virtual audience 112 being presented.

In some instances, the analyzer 135 can perform analysis to identify members of the virtual audience 112 having certain moods, emotions, levels of activity and/or the like. In some implementations, the analysis can be a facial recognition analysis, a partial facial recognition analysis, a machine learning analysis (e.g., executed on or by the host device 130 and/or the analyzer 135) that is based on facial recognition and that is trained to detect facial expressions, and/or any other suitable analysis. For example, the analyzer 135 can identify members of the virtual audience 112 that are smiling, dancing, yelling, frustrated, excited, disappointed, and/or the like. Similarly, the analyzer 135 can identify members of the virtual audience 112 that are sleeping, not moving, have their eyes closed, and/or the like and can avoid presenting such members of the virtual audience 112. In some instances, such analytics performed by the analyzer 135 can automatically determine which members of the virtual audience to present and/or can be used as a filter to reduce a number of members of the virtual audience 112 an individual such as a producer reviews prior to the producer determining which members of the virtual audience 112 to present (e.g., the producer may review only the tiles meeting a certain predetermined score or threshold based on the analytics performed by the analyzer 135).

While the analyzer 135 is described above as automatically determining which members of the virtual audience 112 to present and/or as filtering members of the virtual audience 112 to aid, for example, a producer in selecting which members of the virtual audience 112 to present, in some implementations, the analyzer 135 can determine which members of the virtual audience 112 to present based on input from one or more users (e.g., the users of the user devices 120). Said another way, in some implementations, the host device 130 and/or the analyzer 135 can be configured to determine which member(s) of the virtual audience 112 to present (or emphasize, highlight, expand or enlarge, audio focus, etc.) based on “crowd sourcing” data received from the users of the user devices 120, the participants of the event 111, and/or any other input. For example, a user can manipulate an associated user device 120 to select, like, favorite, and/or otherwise indicate his or her favorite member(s) of the virtual audience 112 and/or the member(s) of the virtual audience 112 that he or she has an interest in watching and/or hearing. In some instances, such a selection can be based on one or more responses and/or reactions to the event 111, based on notoriety and/or level of fame, based on audio (e.g., one or more things said are funny or interesting), and/or any other criterion(ia).

Additionally, the host device 130 and/or the analyzer 135 can be configured to determine which member(s) of the virtual audience 112 to not present or to deemphasize based on “crowd sourcing” data received from the users of the user devices 120, the participants of the event 111, and/or any other input. For example, users can indicate their dislike for particular members of the virtual audience 112. In some implementations, members of the virtual audience 112 with the highest number of likes and/or favorites can be presented in the virtual audience 112, while those with the highest number of dislikes (and/or the fewest number of likes) are not presented or are presented in tiles that have a smaller size, less desirable position, and/or the like. In some instances, instead of automatically presenting the members of the virtual audience 112 with the highest number of likes 112, the analyzer 135 can be configured to filter out and/or reduce a number of video streams (e.g., associated with the members of the virtual audience 112) that an individual such as a producer reviews prior to the producer determining which members of the virtual audience 112 to present (or emphasize). Similarly stated, the crowd sourcing data can be used as a filter such that the producer only reviews media data associated with the members of the virtual audience 112 with the highest number of likes and/or favorites for presentation.

In some implementations, such crowd sourcing can be used in conjunction with any of the automated analysis (e.g., video and/or audio analysis) described above to either automatically select members of the virtual audience 112 to present or to provide a filter for the users such that a producer only reviews a subset of the media data received from the user devices 120 before selecting the members of the virtual audience 112 to present. Moreover, any other suitable crowd sourcing, analytics (e.g., data, image, video, audio, etc.), data from user profiles, history of a user being a member of other virtual audiences, premium status of a user, contextual data (e.g., contextual data associated with a user, a user profile, an event, a venue, a broadcast time, etc.), and/or the like can be used alone or in conjunction with other methods to select or aid in selection of members of the virtual audience 112 to present.

Moreover, in some instances, the presenter 136 can be configured to highlight and/or feature (e.g., show on one or more larger and/or additional screens such as screen 240 in FIG. 5) one or more members of the virtual audience 112 who satisfy one or more criterion or who have reactions and/or responses to the event 111 that satisfy a criterion. For example, the presenter 136 can highlight the tile associated with a member of the virtual audience 112 who is a celebrity, who is famous, who paid for a premium status, and/or the like. As another example, the presenter 136 can highlight the tile associated with the member of the virtual audience 112 having the biggest, best, worst, funniest, and/or most interesting reaction or response. In some instances, the system 100 and/or the host device 130 can provide a competition and/or game associated with the reactions and/or responses of the members of the virtual audience 112. In some instances, the presenter 136 can rotate and/or cycle through the members of the virtual audience 112 (e.g., with or without one or more biases based on reactions and/or the like). Furthermore, in some instances, a user can control and/or select the rotating and/or cycling of the members of the virtual audience 112 for the media data that is provided to that user (e.g., via the corresponding user device 120).

While the presenter 136 is described above as being configured to determine which members of the virtual audience 112 to present, highlight, and/or feature based on, for example, a reaction and/or response to the event 111, in some implementations, the host device 130 can be configured such that the presenter 136 presents the members of the virtual audience 112 performing one or more actions (e.g., collectively as group or any number of subgroups). For example, in some implementations, the presenter 136 can present the members of the virtual audience 112 performing a “wave” as is commonly done by live audiences (e.g., at a sporting event or the like). More specifically, in some instances, the media data received from each user device 120 can depict the corresponding user (or a group of users within the field of view of the media capture device (camera)) moving from a seated position to a standing position, raising his or her hands, and/or the like. The analyzer 135 can, for example, analyze the media data received from the user devices 120 (e.g., using facial recognition analytics, video analytics, image analytics, audio analytics, machine learning, artificial intelligence, and/or any other suitable analysis) to determine which members of the virtual audience 112 are participating in the “wave” and then can be configured to send an instruction to the presenter 136 indicative of an instruction to present adjacent tiles in a serial manner with a slight time delay such that the user(s) depicted in the tiles are shown as standing and/or otherwise moving one after the other to perform a “virtual wave.”

As another example, an indication (e.g., a notification, a message, a request, an indication, etc.) can be provided to each user in a virtual audience 112 or to a subset of users in the virtual audience 112 (e.g., family, friends, colleagues, and/or other users sharing a connection or relationship; users from a specific geographic area; users who have indicated that they are fans of a specific team; users wearing specific colors, memorabilia, costumes, hats, etc.; users associated with a specific school, college, team, etc.; users having predetermined physical characteristics such as having long hair, being tall, etc.; and/or the like) of when to stand such that a “virtual wave” is presented and is coordinated on the screen. In some instances, a producer or the like can trigger, initiate, send (or cause to be sent) such an indication, message, etc. In some instances, a user can trigger and/or initiate a virtual wave by messaging one or more other users (e.g., such as the subset of users mentioned above), who in response, stand and/or otherwise perform an action associated with the virtual wave. In other instances, the host device 130 and/or the presenter 136 can be configured to present a virtual wave or other coordinated cheer or action in any suitable manner.

While the presenter 136 is described above as presenting the members of the virtual audience 112 performing a virtual wave, it should be understood that this has been provided by way of example only and not limitation. The presenter 136, for example, can present one or more members of the virtual audience 112 performing any individual or collective activity. For example, in some instances, the members of the virtual audience 112 can perform and/or can be presented as or when performing a flash mob, a collective and/or coordinated dance, cheer, first pumping, etc., presented as wearing rally caps and/or having or holding other cheer items, signs, etc., presented jingling keys and/or using any suitable noise making device, and/or the like. As another example, the presenter 136 can present the media data received from multiple different user devices 120 that depict the user of that user device 120 displaying one or more letters (e.g., via a sign, body paint, and/or the like). More specifically, the host device 130, analyzer 135, and/or presenter 136 can recognize the one or more letters (e.g., via any of the analytics described herein), can arrange the media data to produce or spell a word using the one or more letters (e.g., “D-E-F-E-N-S-E″), and can present the media data in a single tile or in two or more adjacent tiles. Moreover, media data associated with the event 111 and depicting the collective activity or the like can be sent, provided, and/or broadcast to a subset of the users devices 120, all the user devices 120, and/or any other device configured to receive such a broadcast (e.g., a television).

While the virtual wave and/or other forms of audience engagement or collective activity are described above as being performed in response to an indication, notification, message, etc., in some implementations, the host device 130 can, for example, use analytics such as those described herein (e.g., facial recognition analytics, video analytics, image analytics, audio analytics, machine learning, artificial intelligence, and/or any other suitable analysis) to automatically create a virtual wave and/or other form of collective activity without a specific coordinated effort to do so. By way of example, the host device 130 and/or the analyzer 135 can analyze the media data received from two or more user devices to identify a set of users (members of the virtual audience 112) who happen to be depicted as moving from a seated position to a standing position, who happen to be depicted as raising his or her arms to, for example, stretch, fist pump, and/or the like. Having identified the desired media data (e.g., the media data depicting a user that can be made to appear as though he or she is performing a “wave”), the analyzer 135 (and/or an individual such as a producer or the like) can organize and/or arrange the media data and the presenter 136 can present on the screen tiles associated with the media data in such a way that the members of the virtual audience 112 depicted in the tiles collectively perform a virtual wave.

In some implementations, the host device 130 and/or a producer providing instructions executed by the host device 130 can initiate a virtual wave and/or any other form of audience engagement or collective activity at predetermined and/or desired times during the event 111. For example, when the event 111 is a sporting event or the like, the host device 130 can initiate and/or can be instructed to initiate a virtual wave and/or any other form of audience engagement or collective activity during, for example, a “time out” when an energy level associated with the virtual audience 112 is expected and/or determined to be relatively low. In some implementations, the host device 130 can perform any suitable analytics (e.g., data, image, video, audio, and/or any other analytics described herein) to determine and/or assess an energy level associated with the virtual audience 112. For example, the host device 130 can analyze a collective volume associated with the virtual audience 112, wherein a louder collective volume can be indicative of a more exciting time during the event 111 and a quieter collective volume can be indicative of a less exciting time during the event 111.

While contextual data indicating which team an audience member supports is described above, it should be understood that such contextual data is provided by way of example only and not limitation. In some instances, the presenter 136 can present only certain members of the virtual audience 112 or can present the members of the virtual audience 112 in a certain arrangement based on any suitable data associated with the media data, the event 111, the user, a relationship to one or more users or participants in the event 111, one or more of the user devices 120, and/or the like. For example, in some instances, a graduation (e.g., the event 111) can take place at the venue 105 and the presenter 136 can be configured to present only the members of the virtual audience 112 who share one or more connections with or to a specific graduate (e.g., the graduate being handed a diploma). Such connections can include, for example, family relationships, spousal relationships, friend groups or relationships (e.g., as determined by user provided data, contact data, social media data, and/or any other data described herein).

In some implementations, the presenter 136 can be configured to automatically and/or independently select and/or arrange the members of the virtual audience 112 (“tiles”) based on, for example, one or more predetermined criterion associated with contextual data received from the one or more user devices 120. In some implementations, the presenter 136 can be configured to select and/or arrange the members of the virtual audience 112 in response to and/or based on instructions received from one or more broadcast producers and/or one or more users at least partially controlling the host device 130. In some implementations, the presenter 136 can be configured to select and/or arrange the members of the virtual audience 112 in response to an input or instruction from one or more participants in the event 111. For example, in some instances, the event 111 can be a live show (e.g., talk show, a comedy show, and/or the like) and, in response to a member of the virtual audience 112 heckling and/or otherwise disrupting the show, a participant in the show (e.g., the host, the comedian, and/or any other participant) can send an instruction to the presenter 136 to mute, block, freeze, and/or remove the member of the virtual audience 112.

In some implementations, the presenter 136 can be configured to select and/or arrange the members of the virtual audience 112 in response to and/or based on a preference(s) and/or instruction(s) received from the one or more user devices 120 and/or stored in one or more user profile data structures in the database 140. In some such implementations, the presenter 136 can be configured to present a personalized virtual audience 112 to the users of the user devices 120 that provided the instruction(s). In some implementations, the presenter 136 can be configured to select and/or arrange the members of the virtual audience 112 in response to “crowd sourcing” data (e.g., input or instructions received from a relatively large number of user devices 120). In some such implementations, the presenter 136 can be configured to present the crowd sourced virtual audience 112, which in turn, is broadcast along with the media data captured by the media capture system 110 at the venue 105 (e.g., the virtual audience 112 broadcast to all users can be a crowd sourced virtual audience). Moreover, the media data captured by the media capture system 110 including the crowd sourced virtual audience 112 can be broadcast to each user device 120, to a subset of user devices 120, and/or to any suitable electronic device configured to receive a broadcast (e.g., a television that does not provide the system 100 with media data depicting the person watching the television).

In some instances, the host device 136 can be configured to provide individualized and/or user-specific media streams to each user device 120 that includes members of the virtual audience 112 based on that user’s preferences and/or instructions. Said another way, the presenter 136 can be configured to select and/or arrange the members of the virtual audience 112 for each specific user differently such that each user device 120 is presented a different (or individualized) audience based on, for example, one or more predetermined criterion associated with contextual data received from the one or more user devices 120. For example, a preference, instruction, and/or criterion can be (or can be based on) supporters of the same team, player, athlete, etc.; historical data such as alumni of the same college; family members; friends, connections, contacts, and/or associates; demographic data (e.g., age, race, gender, etc.); level of engagement in the event 111 (e.g., a preference for members of the audience to have relatively large or relatively small reactions in response to the event); political affiliations; and/or any other suitable preference, instruction, and/or criterion. In some implementations, data associated with and/or indicative of at least one preference, instruction, or criterion can be stored in a user profile data structure stored in the database 140 (e.g., received when a user “registers” with the system 100). In other implementations, data associated with and/or indicative of the preference(s), instruction(s), and/or criterion(ia) can be included in and/or derived from contextual data received from the user device 120.

While the analyzer 135 is described above as analyzing media data and/or contextual data to determine whether to include a user as part of the virtual audience, in some implementations the analyzer 135 can use similar methods and/or criteria to analyze media data and/or contextual data to determine whether the user should continue to participate as a member of the virtual audience. The analyzer 135 in some embodiments determines when a characteristic of the received media stream of a virtual attendee indicates that the corresponding virtual attendee should be removed from the virtual audience. Such characteristics include a quality of the received media stream falling below a minimum quality threshold, a connection rate falling below a minimum threshold, a loss of data packets of the received media stream, an absence of the visual representation of the one of the virtual attendees, or inappropriate content within the received media stream. For example, the analyzer 135 can determine and/or detect when a user moves away and/or leaves the field of view of their camera for a predetermined amount of time (e.g., the analyzer 135 detects that a person is not within the field of view of their camera using image analytics), when the size of a user’s face decreases below a predetermined criterion (e.g., the analyzer 135 detects that a person is not as close to their camera using image analytics), when a user turns around and is no longer facing their camera, when the user makes an obscene gesture, when a user that is identified as not having provided an up-to-date consent to participate comes into the field of view of the camera, when a user appears to be asleep, when a user’s video feed appears frozen, when a user has stopped his video feed, when a user is wearing colors or paraphernalia of a team not associated with a specific section of the virtual audience, when a user is swearing, when a user is smoking, when a user is drinking, when a user is wearing a branded piece of clothing, when a user is holding a sign (e.g., where signs are not allowed and/or where the sign has inappropriate content), when someone is walking in the background, and/or the like. For another example, if a known bad actor (e.g., a user who has been identified as previously making obscene and/or inappropriate gestures as indicated by their profile) is identified as participating in the virtual audience under another user’s account, that user can be identified. In some implementations, when such determinations are made, the user can be automatically removed from the virtual audience (e.g., by the presenter 136) without the involvement of a producer. In other implementations, a producer can be automatically notified of such determinations and can make a decision and/or selection regarding whether to remove the user from the virtual audience. Accordingly, removal can be automatic and/or can be based on a producer’s review of the determination.

In some instances, when a user is removed from the virtual audience, that user can be replaced by a different user (e.g., by the presenter 136). For example, the analyzer 135 and/or a producer can maintain a list of backup users that can be ready to join the virtual audience in the event that a participating user is removed from the virtual audience. When a user participating in the virtual audience is removed from the virtual audience, that user can be replaced in the virtual audience by a user from the list of backup users (e.g., by the presenter 136). In some implementations, instead of replacing the user, the depiction of the virtual audience can be optimized for a fewer number of users in the virtual audience (e.g., each tile in the virtual audience can be resized so the tiles collectively fill the screen).

As described herein, facial recognition, facial analysis, behavior analysis, audio recognition, audio analysis, video and/or image analytics, and/or other types of analysis of virtual audience members can be performed (e.g., by analyzer 135) on a virtual audience and/or prospective participants in a virtual audience. Such analysis can be performed using any suitable algorithm, process and/or method used to detect the user’s identity, behavior, appearance, presence, and/or the like. For example, such an analysis can be performed using machine learning models, such as, for example, neural networks, convolutional neural networks, decision tree models, random forest models, and/or the like. Such models can be trained using supervised (e.g., labeled) learning and/or unsupervised learning to identify an identity of a user, to determine a behavior and/or appearance of a user, to determine language used by a user, to determine the presence of a person, object and/or behavior, and/or the like.

In some implementations, the presenter 136 can also include and/or execute a set of instructions that is associated with defining contextual media data associated with one or more members of the virtual audience 112 (e.g., the user(s) of one or more user devices 120). For example, the presenter 136 can be configured to define contextual media data (e.g., a contextual image, video stream, and/or audio stream) associated with a member of the virtual audience 112 that has been identified (e.g., via facial recognition and/or any other suitable analysis) in the media data captured by the media capture system 110 at the venue 105. Said a different way, the presenter 136 can define user-specific contextual media data that, among other things, can depict a specific member of the virtual audience 112 at the venue 105. Once the user-specific contextual media data is defined, the presenter 136 can send a signal associated with the user-specific contextual media data (e.g., via the communication interface 131 and the network 115) to the user device 120, which in turn, can graphically render the user-specific contextual media data on the output device 124 (e.g., the display) of the corresponding user device 120. In such a manner, a user participating in a virtual audience at an event can obtain an image or video of that user reacting or otherwise participating in the event. For example, an image and/or video of the user’s reaction to a particular moment in the event can be identified (e.g., via facial recognition, location identification, a user account, etc.), captured or recorded, and distributed to that user. In some instances, the image and/or video of the user’s reaction can be provided with a video and/or image of the moment in the event. In some instances, the image and/or video of the user’s reaction can be provided with a video and/or image of an avatar or the like interacting with the event (e.g., catching a homerun or foul ball at a baseball game). Moreover, in some instances, the user can manipulate the user device 120 to share the user-specific contextual media data with any of the user devices 120 of the system 100 and/or other electronic devices not necessarily included in the system. In some instances, for example, the user-specific contextual media data can be uploaded to and/or otherwise accessible via an integrated or independent social media platform, sharing site, database, repository, display, and/or the like.

In some instances, the presenter 136 can define user-specific contextual media data when, for example, the host device 130 (e.g., the analyzer 135) determines a member of the virtual audience 112 has a predetermined reaction in response to the event 111 and/or when the member of the virtual audience 112 participates in the event 111 (e.g., by asking a question and/or any other suitable form of participation). In some implementations, the predetermined reaction can be, for example, a reaction that is positive, negative, interesting, funny, and/or otherwise desirable. In some such implementations, the host device 130 (e.g., the analyzer 135) can perform facial recognition, video analytics, image analysis, audio analysis, etc. on the media data associated with the user to determine whether the reaction satisfies a criterion (e.g., associated with the predetermined reaction). As described above, when the analyzer 135 determines that the reaction satisfies the criterion, the presenter 136 can define the user-specific contextual media data (e.g., an image and/or video of the user’s reaction) and can, for example, send the user-specific contextual media data (or an indication or instance thereof) to the user device 120 associated with that member of the virtual audience 112.

Although the presenter 136 and/or other portions of the host device 130 is/are described above as sending a signal to the user device 120 indicative of an instruction to present the user-specific contextual media data on the display of the user device 120, in some instances, the presenter 136 can define the user-specific contextual media data and can send a signal to the database interface 134 indicative of an instruction to associate the user-specific contextual media data with a user profile data structure of the corresponding user and to store the user-specific contextual media data in the database 140.

In some instances, the host device 130 can retrieve the user-specific contextual media data from the database 140 in response to a request from the user device 120 (and/or any other suitable device). More specifically, in some instances, the user can manipulate the user device 120 to access a webpage on the Internet. After being authenticated (e.g., entering credentials or the like) the user can interact with the webpage such that a request for access to the user-specific contextual media data is sent from the user device 120 to the host device 130. Thus, the host device 130 (e.g., the database interface 134) can retrieve the user-specific contextual media data from the database 140 and can send a signal to the user device 120 such that the user-specific contextual media data can be presented on the display (e.g., by rendering the user-specific contextual media data via the Internet and the webpage). In other words, the user-specific contextual media data can be stored on the “cloud” and accessed via a web browser and the Internet (e.g., after an event and/or on-demand). This can allow a user to replay their participation in the event.

Although the database interface 134, the analyzer 135, and the presenter 136 are described above as being stored and/or executed in the host device 130, in some embodiments, any of the engines, components, processes, etc. can be stored and/or executed in, for example, one or more of the user devices 120 and/or the media capture system 110. For example, in some embodiments, the user devices 120 can include, define, and/or store a presenter and/or can otherwise perform at least a portion of the function of the presenter 136 (e.g., via a native application). The presenter can be substantially similar to or the same as the presenter 136 of the host device 130. In such embodiments, the presenter of the user devices 120 can replace the corresponding function of the presenter 136 otherwise included and/or executed in the host device 130. Thus, the presenter of the user devices 120 can receive, for example, a data set associated with user-specific contextual media data and upon receipt, can define a presentation and/or digital representation thereof to be presented on the display of the user devices 120.

Similarly, one or more portions of the analyzer 135 and/or one or more functions of the analyzer 135 can be performed by an analyzer included in one or more of the user devices 120. For example, as described above, in some implementations, one or more facial recognition and/or audio recognition processes can be performed by the processor 122 of a user device 120 (e.g., the processor 122 can include an analyzer and/or can be configured to perform one or more functions of an analyzer).

While the system 100 is described above as providing media data associated with the event 111 to the one or more user devices 120, in some implementations, the system 100 can be configured to provide a platform that also allows data to be transferred between multiple user devices 120. In some instances, the data can be, for example, in the form of a “chat” including text or multimedia messages using any suitable protocol. In some instances, a first user device 120 can send media data captured by the corresponding input device 125 to the host device 130 and to one or more other user devices 120. In this manner, two or more users can share his or her media stream or data with friends, connections, colleagues, relatives, and/or any other users based on any suitable criterion. Moreover, the user devices 120 can be configured and/or manipulated to present the media data associated with the event 111 as well as media data from one or more other user devices 120 on the corresponding output device 124 (e.g., the display of that user device 120). In some implementations, the application executed by or on the user device 120 can present the various streams of media data in any suitable manner.

While the system 100 is described herein as providing media data and/or media stream(s) associated with the event 111 (e.g., a live event) occurring at the venue 105, it should be understood that the systems, methods, and/or concepts described herein are not intended to be limited to such an implementation. For example, in some instances, the system 100 can be configured to provide to one or more user devices 120 media data of and/or associated with any suitable live or pre-recorded broadcast such as, for example, a television show, a movie or film, a pre-recorded sports game or match, etc. In some such instances, the system 100 can allow a user to participate in, for example, a “watch party” or the like, where a user device 120 associated with each user (e.g., each participant) can present media data associated with the broadcast and a “tile” or the like associated with and/or representing media data from each user (participant) via the user device 120 associated with that user. As an example, the system 100 can allow a user and one or more friends could have a “watch party” to watch their favorite television show.

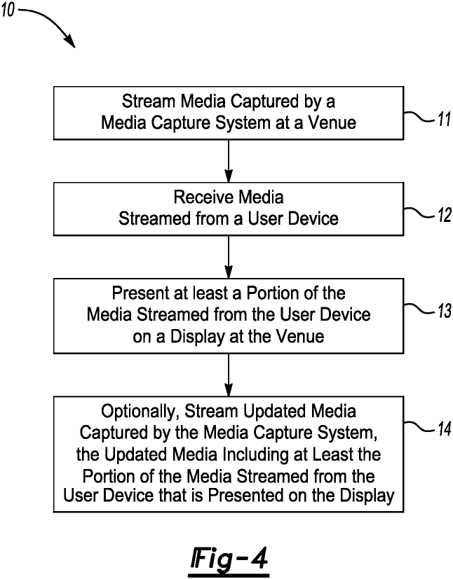

With the apparatus and systems shown in FIGS. 1-3, various methods of virtually engaging a live event can be implemented. As an example, FIG. 4 shows a flowchart illustrating a method 10 for virtually engaging a live event according to an embodiment. In some embodiments, the method 10 can be performed in, on, or by the system 100 described above with reference to FIGS. 1-3. The method 10 can include streaming media captured by a media capture system at a venue, at 11. The media can be streamed, broadcast, and/or otherwise provided to one or more user devices via any suitable modality, protocol, and/or network such as those described herein. The media can be associated with an event occurring at the venue such as, for example, a sporting event, a concert, a wedding, a party, a graduation, a televised or broadcasted live show (e.g., a sitcom, a game show, a talk show, etc.), a political campaign event or debate, and/or any other suitable event. In some instances, the media can depict one or more images, video recordings, and/or audio recordings of the event, a virtual audience graphically represented at the venue, and/or a live audience physically present at the venue.

Media streamed from a user device is received, at 12. For example, in some implementations, a host device and/or any other suitable device can be configured to receive a stream of media data from the user device. In some instances, the media stream received from the user device can include and/or can depict a user associated with that user device such that the user becomes a member of the virtual audience.

At least a portion of the media streamed from the user device is presented on a display at the venue, at 13. For example, as described in detail above with reference to the system 100, the venue can include a videoboard, a screen (e.g., a green screen and/or any other screen on which image and/or video data can be displayed and/or projected), a display, etc. that can present any number of media streams received from one or more user devices (e.g., as “tiles” or the like). In some instances, presenting the media streams from the user devices can allow the users to be members of the virtual audience who virtually participate and/or engage in the live event occur at the venue. In addition, the presentation of the virtual audience at the venue can also allow the participants of the event (e.g., athletes, etc.) to engage and/or respond to the members of the virtual audience, as described above.

In some embodiments, the method 10 can optionally include streaming updated media captured by the media capture system such that the updated media includes at least the portion of the media streamed from the user device that is presented on the display at the venue, at 14. For example, as described above, the media capture system at the venue can be configured to capture media associated with and/or depicting the event, at least a portion of the virtual audience, and/or at least a portion of a live audience. Accordingly, in some instances, the media streamed from the user device (or at least the portion thereof) that is presented on the display at the venue can be depicted in the media captured by the media capture system such that the member of the virtual audience is included and/or depicted in the media stream associated with the event.

While various embodiments have been described above, it should be understood that they have been presented by way of example only, and not limitation. While specific examples have been particularly described above, the embodiments and methods described herein can be used in any suitable manner. A non-limiting example of an embodiment and/or implementation is provided below. It should be understood that the example described below is not intended to summarize the disclosure of the systems, embodiments, and/or methods described herein but rather is presented by way of example and not limitation.

### EXAMPLE

Overview: A system and/or platform can enable individuals to attend sports events, graduations, televised talk shows, television game show tapings, political campaign events, political debates and other events from home (or anywhere else) through an Internet connection which transmits video and audio. The platform was originally conceived as a means of creating a “virtual crowd” to solve for problems arising from “stay-at-home orders”, but the platform has ongoing usefulness and application following resumption of public gatherings as people can continue to form part of a “virtual crowd”, among other benefits providing a venue with no cap on live “seating capacity”. The platform can exist on a standalone basis and/or be embedded (e.g., by way of an SDK) within a participating broadcaster’s own app.

User Registration: The participating individual may be asked to provide various information as part of a registration process (e.g., age, gender, location, favorite sports team, profession, marital status, profession, etc.), thereby permitting filtering/searching later in the process.

The Event:
A. There may be one or more videoboard(s) set up at the event (either with actual hardware and/or electronically: e.g., by way of a green screen; cgi; etc.) on which the virtual audience is displayed (e.g., each on a separate “tile”), thereby permitting participants at the actual event to see and hear the virtual audience.
B. The virtual crowd may be set up in any of multiple configurations: e.g., can be (1) side of an event (e.g., a virtual audience at a television talk show), or surround the entirety of an event (e.g., (4) sides of a basketball court), or otherwise.
C. The virtual crowd may also appear at the event on a selective basis (e.g., during a graduation, only relatives or guests of a particular student may appear virtually behind the podium while the graduate accepts his or her degree).
D. Sound streaming from the virtual audience can be aggregated, thereby creating authentic and real-time fan/crowd noise.

The Broadcast:
A. The production crew can determine which audience “tiles” to display (individually or in groups) at different times during the event, either in background of the event itself and/or otherwise integrated into the broadcast.
B. The system also allows particular audience members to be selected to participate at the event: e.g., asking a question on a television talk show).

The User:
A. Each virtual audience member can search, sort and filter and view other users’ tiles, choosing which if any other audience members to focus on during a broadcast.
B. Each member of the audience can configure their own audience (e.g., a University of Michigan fan can view the game with an audience comprised solely of University of Michigan fans).
C. Each virtual audience member can view the event through the user’s own electronic device
D. Members of the virtual audience may selectively interact with one another (through chat, message, and/or other like features).
E. Members of the virtual audience may interact with the venue/event.

Additional Functionalities: Certain additional functionalities of a commonly owned system integrate into this system, permitting a user to receive a short-clip of the user’s appearance at the public event as they may have been highlighted in the audience during the broadcast. Clips can be distributed to the user based on facial recognition and/or based on the source of the user’s own streaming web-feed.

System Flow:
A. User registers
B. User watches an event over an Internet connection
C. User streams user content during the event (audio and video)
D. A live virtual crowd is uploaded to the event
E. The live virtual crowd can be seen and heard at the event itself
F. Members of the virtual crowd can interact with one another
G. The event broadcasts back on television or otherwise, in a manner which may highlight particular audience members
H. Audience members depicted on the broadcast feed can receive their “moments” consistent with certain functionalities described herein.

While the system 100 is described above as providing media data associated with a sporting event and/or a member of a virtual audience at a sporting event, in some implementations, the system 100 can be used in any suitable setting, venue, arena, event, etc., such as a concert, a rally, a graduation, a party, a shopping mall, a place of business, a debate, etc. In addition, an event can be a live event occurring at a venue or can be a pre-recorded event, broadcast, and/or media stream. As another example, while the system 100 is described above as performing facial recognition analysis on media data, in some implementations, a host device can be configured to analyze any suitable source of audio to identify a user and/or one or more people connected to the user. In some instances, audio or voice analysis can be performed in addition to the facial recognition analysis described herein. In some instances, audio or voice analysis can be performed instead of or as an alternative to the facial recognition analysis described herein.

While the embodiments have been described above as being performed on specific devices and/or in specific portions of a device, in other embodiments, any of the embodiments and/or methods described herein can be performed on any suitable device. For example, while the system 100 is described as including the host device 130, in some embodiments, a system can include multiple host devices providing any suitable portion of a media stream. In some embodiments, one or more processes can be performed on or at a user device such as, for example, one or more processes associated with facial recognition analysis and/or modifying or editing media data into a standardized format prior to sending the media data to other devices via a network. In some instances, such standardization can decrease a workload of one or more host devices and/or can reduce latency associated with defining and/or presenting a virtual audience, and/or otherwise utilizing the system 100. In some embodiments, the system 100 can be performed on a peer-to-peer basis without a host device, server, etc.

While the embodiments have been particularly shown and described, it will be understood that various changes in form and details may be made. Although various embodiments have been described as having particular features and/or combinations of components, other embodiments are possible having a combination of any features and/or components from any of embodiments as discussed above.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above.

While specific methods of transmitting, analyzing, processing, and/or presenting media data have been described above, any of the methods of transmitting, analyzing, processing, and/or presenting media can be combined, augmented, enhanced, and/or otherwise collectively performed on a media data set. For example, in some instances, a method of facial recognition can include analyzing facial data using Eigenvectors, Eigenfaces, and/or other 2-D analysis, as well as any suitable 3-D analysis such as, for example, 3-D reconstruction of multiple 2-D images. In some instances, the use of a 2-D analysis method and a 3-D analysis method can, for example, yield more accurate results with less load on resources (e.g., processing devices) than would otherwise result from only a 3-D analysis or only a 2-D analysis. In some instances, facial recognition can be performed via convolutional neural networks (CNN) and/or via CNN in combination with any suitable two-dimensional (2-D) and/or three-dimensional (3-D) facial recognition analysis methods. Moreover, the use of multiple analysis methods can be used, for example, for redundancy, error checking, load balancing, and/or the like. In some instances, the use of multiple analysis methods can allow a system to selectively analyze a facial data set based at least in part on specific data included therein.

As another example, in some instances, the system 100 can be implemented in or with one or more augmented reality (AR) systems, platforms, devices, etc. For example, while the media data is described above as being presented (e.g., by the presenter 136) on a display or screen at the venue 105, in other implementations, the media data associated with the virtual audience 112 can be sent to an AR-capable device viewed and/or worn by a performer and/or participant in the event 111. In some instances, the user device 120 can be configured to include, present, and/or provide an AR environment and/or experience to the user that includes media data captured by the media capture system 110 and all or any portion of the virtual audience 112.

While the system 100 is described herein as transferring, analyzing, processing, and/or presenting media data that can include video data, images, audio data, and/or the like, in some implementations, the system 100 can be configured to present media data that includes instructions for one or more user devices 120 to produce any suitable haptic, tactile, and/or sensory output. For example, in some instances, the host device 130 can be configured to send to one or more user devices 120 media data associated with and/or depicting the virtual audience 112 loudly cheering in response to the event 111. In some such instances, the media data can also include data and/or an instruction that causes the user device 120 to shake, vibrate, and/or the like (e.g., via the vibration device of a smartphone, and/or other suitable mechanisms). As another example, a user device 120 can produce a “thump” or similar output when the event 111 is a concert or the like that includes and/or plays loud bass or similar sounds.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware sections may include, for example, a general-purpose processor, a field programmable gate array (FPGA), and/or an application specific integrated circuit (ASIC). Software sections (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The preceding description is illustrative rather than limiting in nature. Variations and modifications to the disclosed example embodiments may become apparent to those skilled in the art that do not necessarily depart from the essence of the disclosed examples. The scope of legal protection provided to the invention can only be determined by studying the following claims.

1-25. (canceled)

26. A method of hosting a virtual audience during a live event at a physical venue, the method comprising:
distributing an observable representation of the live event to be received by a plurality of user devices located remote from the physical venue;
receiving a live video stream from each of a plurality of persons located remote from the physical venue, each received live video stream including a visual representation of at least one of the plurality of persons; and
displaying, on a physical display at the physical venue, the live video stream of at least some of the persons such that the persons appear to be attending the live event as virtual attendees at the physical venue.

27. The method of claim 26, wherein
the received live video streams include audio representing sounds made by the virtual attendees, and
the method includes reproducing the sounds within the physical venue so the sounds made by the virtual attendees are audible at the physical venue.

28. The method of claim 26, comprising
determining contextual information corresponding to each received live video stream, and
selecting the at least some of the virtual attendees for the displaying based on the contextual information.

29. The method of claim 28, comprising
using at least one of facial recognition or voice recognition for recognizing at least one individual in each received live video stream,
including a result of the facial recognition or voice recognition in the contextual information, and
selecting the at least some of the virtual attendees based on the included result of the facial recognition or voice recognition.

30. The method of claim 29, comprising selecting a position of the visual representation of the recognized individual within the physical venue based on the result of the facial recognition or voice recognition.

31. The method of claim 30, comprising grouping the visual representation of some of the plurality of virtual attendees within the physical venue based on the result of the facial recognition or voice recognition.

32. The method of claim 29, comprising
determining at least one other characteristic of the live video stream including a recognized individual, and
selecting a position of the visual representation of the recognized individual within the physical venue based on the at least one other characteristic.

33. The method of claim 32, comprising grouping the visual representation of some of the plurality of virtual attendees within the physical venue based on a similarity between the determined at least one other characteristic of the respective live video streams of the some of the plurality of virtual attendees.

34. The method of claim 28, wherein
the contextual information comprises user profile data regarding a corresponding one of the received live video streams, and
the method includes determining, based on the user profile data, whether the visual representation of the corresponding one of the received live video streams should be included among the displayed virtual attendees.

35. The method of claim 34, comprising establishing a peer networking session between some of the virtual attendees during the event based on at least one of
a choice or selection made by one of the virtual attendees to be in the peer networking session with at least one other of the virtual attendees, or
the user profile data of each of some of the plurality of virtual attendees indicating an association between the some of the virtual attendees.

36. The method of claim 26, comprising
determining that at least one of the persons appears in the distributed observable representation of the live event or appears on a dedicated display at the physical venue during the event; and
sending a media file to the at least one of the persons during or after the live event, wherein the sent media file includes the appearance of the at least one of the persons.

37. The method of claim 26, comprising selecting at least one of the virtual attendees and displaying the visual representation of the selected at least one of the virtual attendees differently than others of the visual representations of the virtual attendees for at least a portion of the event.

38. The method of claim 39, comprising facilitating an interaction between an individual at the physical venue participating in the event and the selected at least one of the virtual attendees while displaying the visual representation of the selected at least one of the virtual attendees differently than others of the visual representations of the virtual attendees.

39. The method of claim 26, comprising removing the visual representation of one of the virtual attendees from the display based on at least one characteristic of the received live video stream from the at least one of the virtual attendees, wherein the at least one characteristic is
a quality below a minimum quality threshold,
a connection rate below a minimum threshold,
a loss of data packets,
an absence of the visual representation of the one of the virtual attendees, or
inappropriate content.

40. A system for hosting a virtual audience during a live event at a physical venue, the system comprising:
a camera arrangement situated at the physical venue, the camera arrangement being configured to capture an observable representation of the live event;
a distribution device that is configured to distribute the observable representation of the live event to be received by a plurality of user devices located remote from the physical venue;
a host device including
a communication interface configured to receive a live video stream from each of a plurality of virtual attendee user devices located remote from the physical venue, each received live video stream including a visual representation of at least one of a plurality of persons,
at least one processor that is configured to analyze the received live video streams and to select at least some of the visual representations of corresponding ones of the plurality of persons; and
at least one display situated at the physical venue, the host device causing the at least one display to include the visual representation of the selected at least some of the visual representations such that the persons corresponding to the selected visual representations appear to be attending the live event as virtual attendees at the physical venue.

41. The system of claim 40, comprising at least one speaker, and wherein
the received live video streams include audio representing sounds made by the persons;
the host device causes the at least one speaker to reproduce the sounds within the physical venue so the sounds made by the persons are audible at the physical venue; and
the at least one display comprises
a display panel that is configured to include multiple visual representations of virtual attendees, or
a plurality of display panels each configured to include a single visual representation of a corresponding virtual attendee.

42. The system of claim 40, wherein the at least one processor is configured to
use at least one of facial recognition or voice recognition for recognizing at least one of the persons in each received live video stream,
select the at least some of the visual representations for displaying the virtual attendees based on the facial recognition or voice recognition.

43. The system of claim 42, wherein the at least one processor is configured to select a position of the visual representation of the recognized one of the persons on the at least one display based on the result of the facial recognition or voice recognition.

44. The system of claim 43, wherein the at least one processor is configured to
determine at least one other characteristic of the live video stream including the recognized one of the persons, and
select a position of the visual representation of the recognized one of the persons on the at least one display based on the at least one other characteristic.

45. The system of claim 40, wherein
the at least one processor is configured to determine user profile data regarding a corresponding one of the received live video streams, and
the at least one processor is configured to determine, based on the user profile data, whether the visual representation of the corresponding one of the received live video streams should be included among the displayed virtual attendees.
